(19) United States
(12) Patent Application Publication
(10) Pub. No.: US 2015/0200455 A1
(43) Pub. Date: Jul. 16, 2015

(54) ANTENNA FEED

(71) Applicant: ALCATEL LUCENT, Boulogne Billancourt (FR)

(72) Inventors: Vijay Venkateswaran, Blanchardstown (IE); Florian Pivot, Blanchardstown (IE); Titos Kikkinos, Bietigheim-Bissingen (DE)

(73) Assignee: ALCATEL LUCENT, Boulogne Billancourt (FR)

(21) Appl. No.: 14/421,339

(22) PCT Filed: Aug. 2, 2013
(86) PCT No.: PCT/EP2013/002306

§ 371 Date: Feb. 12, 2015

(30) Foreign Application Priority Data
Aug. 14, 2012 (EP) 12360065.2

(51) Int. Cl. H01Q 3/36; H01Q 3/28

(52) U.S. Cl. CPC H01Q 3/36; H01Q 3/28

(57) ABSTRACT

An antenna feed and methods are disclosed. The antenna feed is for generating signals for an antenna array for transmitting a transmission beam having one of a plurality of different tilt angles, the antenna feed comprises: a digital signal processor operable to receive an input broadband signal and to generate, in response to a requested tilt angle, a plurality N of output broadband signals, each having an associated phase and amplitude; a plurality N of transmission signal generators, each operable to receive one of the plurality N of output broadband signals and to generate a corresponding plurality N of first RF signals; a feed network operable to receive the plurality N of first RF signals and to generate a plurality P of second RF signals, each of the plurality P of second RF signals having an associated amplitude and phase, the plurality P of second RF signals being used to generate a plurality M of third RF signals, where P is no less than M, each third RF signal having an associated phase and amplitude for supplying to a corresponding antenna of a plurality M of antennas of the antenna array to transmit the transmission beam with the requested tilt angle. By increasing the number of signals generated within the feed network, which are utilized to generate the third RF signals for supplying to the antenna, the range of possible tilt angles is increased as are the possible range of beam patterns in order to satisfy the coverage and capacity requirements.

### FIELD OF THE INVENTION

The present invention relates to an antenna feed and methods.

### BACKGROUND

Antenna feeds are known. In order to support the spatial separation of signals from a static transmitter of, for example, a wireless telecommunications network, it is known to provide an array of antennas and utilise beamforming techniques. In particular, a signal may be provided which is subjected to varying phase and amplitude to generate multiple signals, each of which is provided to one of the antennas in the array in order to perform adaptive beamforming, virtual sectorisation and spatial multiplexing within a given cell. Such antenna arrays are typically referred to as active antenna arrays. These arrays significantly increase the coverage and capacity of a cellular network.

Although such antenna arrays provide for increased benefits, unexpected consequences can occur.

Accordingly, it is desired to provide an improved technique for generating signals to be provided to an antenna array.

### SUMMARY

According to a first aspect, there is provided an antenna feed for generating signals for an antenna array for transmitting a transmission beam having one of a plurality of different tilt angles, the antenna feed comprising: a digital signal processor operable to receive an input broadband signal and to generate, in response to a requested tilt angle, a plurality N of output broadband signals, each having an associated phase and amplitude; a plurality N of transmission signal generators, each operable to receive one of the plurality N of output broadband signals and to generate a corresponding plurality N of first RF signals; a feed network operable to receive the plurality N of first RF signals and to generate a plurality P of second RF signals, each of the plurality P of second RF signals having an associated amplitude and phase, the plurality P of second RF signals being used to generate a plurality M of third RF signals, where P is no less than M, each third RF signal having an associated phase and amplitude for supplying to a corresponding antenna of a plurality M of antennas of the antenna array to transmit the transmission beam with the requested tilt angle.

The first aspect recognizes that a problem with existing techniques for generating signals for an antenna array is that either a completely separate transceiver chain is required to generate a signal for each antenna array or, if a reduced number of transceivers is provided in order to reduce the size and weight of the antenna feed, then the range of tilt angles achieved and the resulting beam patterns do not always satisfy coverage and capacity requirements and it is not always possible to decouple the relationship between the number of transceivers and the number of antennas in the array.

Accordingly, an antenna feed may be provided. The antenna feed may generate signals to be provided to an antenna array which may transmit a transmission beam with any one of a number of different tilt angles. The antenna feed may comprise a digital signal processor which receives an input digital broadband signal and may generate a number of output digital broadband signals. Each of the output broadband digital signals may have an associated phase and angle. The number of broadband digital signals generated may be N. A number N of transmissions signal generators may also be provided. Each of the signal generators may receive one of the output broadband digital signals and may generate a corresponding first radiofrequency [RF] signal. A feed network may be provided which receives each of the first RF signals and may generate a number of second RF signals. Each of the second RF signals may have an associated amplitude and phase. The second RF signals may be used to generate a number of third RF signals. Each of the third RF signals may have an associated phase and amplitude. Each of the third RF signals may be supplied to a corresponding antenna of an antenna array for transmission of the transmission beam with the requested tilt angle. The number of second RF signals may be greater than or equal to the number of third RF signals.

By increasing the number of signals generated within the feed network, which are utilized to generate the third RF signals for supplying to the antenna, the range of possible tilt angles is increased as are the possible range of beam patterns in order to satisfy the coverage and capacity requirements.

In one embodiment, the tilt angle is an angle offset from an azimuth and elevation offset from a direction which is normal to a plane on which the plurality M of antennas of the antenna array are positioned. Accordingly, tilt angles other than downtilt angles may be achieved.

In one embodiment, the digital signal processor is operable to generate the plurality N of output broadband signals, each having a differing phase and amplitude.

In one embodiment, N is less than M. Accordingly, the required transmission beams may still be generated even using a reduced number of transmissions signal generators compared to the number of antennas. This is possible because the feed network generates additional signals for feeding to the antenna array. This reduces cost, complexity, power consumption and weight.

In one embodiment, the feed network comprises a power split network operable to receive the plurality N of first RF signals and to generate a plurality P of power split RF signals, wherein P is greater than N. Accordingly, the feed network generates additional signals by splitting the first RF signals.

In one embodiment, the power split network comprises power splitters, each operable to divide each of the plurality N of first RF signals over at least two separate paths to generate the plurality P of power split RF signals.

In one embodiment, the power split network comprises a plurality of stages, each comprising power splitters, each stage dividing received RF signals over at least two separate paths and providing those to a subsequent stage to generate the plurality P of power split RF signals.

In one embodiment, the power split network comprises three stages.

In one embodiment, each power splitter is operable to divide received RF signals over at least two separate paths with an associated power split ratio.

In one embodiment, the associated power split ratio comprises one of an equal and an unequal power split ratio.

In one embodiment, the feed network comprises a phase shift network operable to receive the plurality P of power split RF signals and to apply a phase shift on each of the plurality P of power split RF signals. Accordingly, each of the received power split RF signals [each of which may have a differing amplitude and phase] may be subjected to a further phase shift by the phase shift network.

In one embodiment, the phase shift network is operable to receive the plurality P of power split RF signals and to generate a plurality P of phase shifted RF signals as the plurality P of second RF signals.

In one embodiment, each of the plurality P of power split RF signals is phase shifted with an associated phase shift.

In one embodiment, the phase shift network comprises a plurality P of transmission lines, each operable to apply an associated phase shift. It will be appreciated that many different devices may be utilized to perform such a phase shift.

In one embodiment, the phase shift network comprises interconnects operable to reorder the plurality P of phase shifted RF signals. By providing an interconnect within the phase shift network, the need to reorder signals elsewhere within the antenna feed may be obviated.

In one embodiment, the interconnects comprise transmission lines, each operable to apply an associated phase shift.

In one embodiment, the feed network comprises a coupling network operable to receive the plurality P of phase shifted RF signals and to combine some of the plurality P of phase shifted RF signals to generate the plurality M of third RF signals, where M is less than P. Accordingly, the coupler and network may combine 2 or more of the phase shifted RF signals to generate the third RF signals. Such combining may help to generate the appropriate number, phase and amplitude of signals to supply to the antenna array in order to enable the antenna array to generate transmission beams having the desired tilt angles.

In one embodiment, the coupling network comprises combiners operable to combine received signals to generate a combined signal and a loss signal, the loss signal being combined with other received signals to reduce losses at different tilt angles. By recombining the loss signal with other signals, the losses caused by the feed network at different tilt angles may be reduced. In particular, the combiners may combine some of the plurality P of phase shifted RF signals to generate a combined signal and a loss signal. The loss signal then may be combined with other of the plurality of phase shifted RF signals or other combined signals all loss signals to reduce losses at different tilt angles.

In one embodiment, the coupling network comprises a plurality of stages, each comprising combiners, loss signals from a previous stage being provided to a combiner of a subsequent stage to generate the plurality M of second RF signals.

In one embodiment, each stage comprises fewer than the plurality P of combiners.

In one embodiment, the combiners comprise one of hybrid couplers, rat-race couplers and Wilkinson combiners.

In one embodiment, the transmission signal generators comprise transceivers

According to a second aspect, there is provided a method of configuring an antenna feed for generating signals for an antenna array for transmitting a transmission beam having one of a plurality of different tilt angles, the method comprising: estimating an arrangement of a feed network which optimises performance for the plurality of different tilt angles, the feed network being arranged to receive a plurality N of first RF signals and to generate a plurality P of second RF signals, each of the plurality P of second RF signals having an associated amplitude and phase, the plurality P of second RF signals being used to generate a plurality M of third RF signals, where P is no less than M, each third RF signal having an associated phase and amplitude for supplying to a corresponding antenna of a plurality M of antennas of the antenna array to transmit the transmission beam with the requested tilt angle; reconfiguring the arrangement of the feed network to minimise insertion losses; and determining a function applied by a digital signal processor to generate, from an input broadband signal, in response to a requested tilt angle, a plurality N of output broadband signals, each having an associated phase and amplitude to be provided to a plurality N of transmission signal generators, each being operable to receive one of the plurality N of output broadband signals and to generate a corresponding one of the plurality N of first RF signals.

In one embodiment, the step of estimating comprises using an interior point algorithm to estimate all possible arrangements of the feed network for the antenna array and plurality of different tilt angles.

In one embodiment, the step of estimating comprises using singular value decomposition to estimate, from the all possible arrangements, the arrangement of the feed network which optimises performance for the plurality of different tilt angles.

In one embodiment, the step of estimating comprises using singular value decomposition to estimate, from optimal arrangements, a dominant arrangement of the feed network which optimises performance for the plurality of different tilt angles.

In one embodiment, the step of reconfiguring comprises utilising an orthogonal matching pursuit algorithm and factorisation rules in conjunction with the arrangement of the feed network to reconfigure the arrangement of the feed network to minimise insertion losses.

In one embodiment, the step of determining comprises estimating the function by minimising a mean squared cost function utilising performance constraints, an antenna response model and a feed network model.

In one embodiment, the step of determining comprises configuring the digital signal processor amplitude and phase function by minimising a mean squared cost function utilising performance constraints, an antenna response model and a feed network model.

According to a third aspect, there is provided a computer program product operable, when executed on a computer, to perform the method steps of the second aspect.

According to a fourth aspect, there is provided a method of generating signals for an antenna array for transmitting a transmission beam having one of a plurality of different tilt angles, comprising: receiving an input broadband signal and to generate, in response to a requested tilt angle, a plurality N of output broadband signals, each having an associated phase and amplitude; receiving one of the plurality N of output broadband signals and generating a corresponding plurality N of first RF signals; receiving the plurality N of first RF signals and generating a plurality P of second RF signals, each of the plurality P of second RF signals having an associated amplitude and phase, using the plurality P of second RF signals to generate a plurality M of third RF signals, where P is no less than M, each third RF signal having an associated phase and amplitude for supplying to a corresponding antenna of a plurality M of antennas of the antenna array to transmit the transmission beam with the requested tilt angle.

In one embodiment, the tilt angle is an angle offset from an azimuth and elevation offset from a direction which is normal to a plane on which the plurality M of antennas of the antenna are positioned.

In one embodiment, the plurality N of output broadband signals each have a differing phase and amplitude.

In one embodiment, N is less than M.

In one embodiment, a plurality P of power split RF signals are generated from the plurality N of first RF signals, wherein P is greater than N.

In one embodiment, the plurality N of first RF signals are divided over at least two separate paths to generate the plurality P of power split RF signals.

In one embodiment, the plurality P of power split RF signals are generated in a plurality of stages, each stage dividing received RF signals over at least two separate paths and providing those to a subsequent stage.

In one embodiment, the plurality P of power split RF signals are generated using three stages.

In one embodiment, received RF signals are divided over at least two separate paths with an associated power split ratio.

In one embodiment, the associated power split ratio comprises one of an equal and an unequal power split ratio.

In one embodiment, the plurality P of power split RF signals are received and a phase shift is applied to each of the plurality P of power split RF signals.

In one embodiment, the plurality P of power split RF signals are received and a plurality P of phase shifted RF signals are generated as the plurality P of second RF signals.

In one embodiment, each of the plurality P of power split RF signals is phase shifted with an associated phase shift.

In one embodiment, an associated phase shift is applied using a plurality P of transmission lines.

In one embodiment, the plurality P of phase shifted RF signals are reordered.

In one embodiment, the plurality P of phase shifted RF signals are received and some of the plurality P of phase shifted RF signals are combined to generate the plurality M of third RF signals, where M is less than P.

In one embodiment, received signals are combined to generate a combined signal and a loss signal, the loss signal being combined with other received signals to reduce losses at different tilt angles.

In one embodiment, loss signals from a previous stage are provided to a subsequent stage to generate the plurality M of second RF signals.

In one embodiment, each stage comprises fewer than the plurality P of combiners.

In one embodiment, the combiners comprise one of hybrid couplers, rat-race couplers and Wilkinson combiners.

In one embodiment, the transmission signal generators comprise transceivers.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION OF THE DRAWINGS

Embodiments of the present invention will now be described further, with reference to the accompanying drawings, in which:

FIG. 1 illustrates the general architecture of an antenna feed according to one embodiment;

FIG. 2 illustrates schematically the arrangement of the antenna feed network of FIG. 1;

FIG. 3 illustrates schematically the arrangement of a bank of power dividers according to one embodiment;

FIG. 4 illustrates schematically the arrangement of the bank of phase shifters according to one embodiment;

FIG. 5 illustrates schematically the arrangement of the bank of couplers according to one embodiment;

FIG. 6 illustrates the performance of the antenna feed of FIGS. 3 to 5 with a static downtilt of 8°;

FIG. 7 illustrates the performance of the antenna feed of FIGS. 3 to 5 under dynamic downtilt of 5 and 10°;

FIG. 8 illustrates schematically the arrangement of a bank of power dividers according to one embodiment;

FIG. 9 illustrates schematically the arrangement of the bank of phase shifters according to one embodiment;

FIG. 10 illustrates schematically the arrangement of the bank of couplers according to one embodiment;

FIG. 11 illustrates the performance of the antenna feed of FIGS. 8 to 10 with a static downtilt of 8°;

FIG. 12 illustrates the performance of the antenna feed of FIGS. 8 to 10 under dynamic downtilt of 2 and 14°;

FIG. 13 illustrates the method steps which estimate the optimal antenna feed network for all possible downtilts given the performance constraints (such as side-lobe levels, 3 dB beamwidth);

FIGS. 14 and 15 illustrate the method steps which uses the optimal antenna feed network estimated in FIG. 13 and redesigns the antenna feed network to minimize insertion losses;

FIG. 16 illustrates the method steps which utilize the redesigned antenna feed network and required downtilt to estimate the parameters for the digital beam former;

FIG. A1 illustrates an antenna feed according to one embodiment;

FIG. A2 illustrates simulation results according to embodiments;

FIG. A3 illustrates cellular sectorisation;

FIG. A4 illustrates an antenna feed according to one embodiment;

FIG. A5 illustrates a bank of power dividers according to one embodiment;

FIG. A6 illustrates schematically the arrangement of the bank of couplers according to one embodiment;

FIG. A7 illustrates schematically the arrangement of a rat race coupler;

FIGS. A8 to A10 show the performance of embodiments;

FIG. A11 illustrates an antenna feed according to one embodiment; and

FIG. A12 show the performance of embodiments.

### DESCRIPTION OF THE EMBODIMENTS

Overview

Before discussing the embodiments in any more detail, first an overview will be provided. As mentioned above, it is difficult to provide a simplified feed network which can efficiently generate signals through adaptive beamforming for a range of different tilt angles. In particular, in order to efficiently provide beamforming for a range of different tilt angles it would typically be required to provide a single transceiver coupled with each antenna of the antenna array, but this is not always possible, it creates additional weight and increases the cost and power consumption which is undesirable, particularly when the transceivers are co-located with the antennas on the mast.

Accordingly, embodiments provide an arrangement where fewer transceivers are utilized and the signals generated by those fewer number of transceivers are provided to the antenna array via an antenna feed network. In particular, fewer transceivers than the number of antennas in the antenna array are provided. The transceivers are driven by a digital signal processor or digital beamformer which receives a digital broadband signal to be transmitted by the antenna array with a requested tilt angle. The tilt angle may be provided separately or as part of the digital broadband signal.

The digital broadband signal is received by the digital signal processor together with the required tilt angle. The digital signal processor generates a number of digital broadband signals which matches the number of transceivers provided. Each of the digital broadband signals will have a different phase and amplitude, dependent on the requested tilt angle. Each transceiver generates a radiofrequency [RF] signal and provides this to an antenna feed network. The antenna feed network generates a number of signals from the signals provided by the transceivers which exceeds the number of antennas in the antenna array. These greater number of signals are subsequently recombined within the antenna feed network to provide a single signal for each antenna in the antenna array.

Such generation and recombination of signals within the antenna feed network enables fewer transceivers to be provided and also enables losses which may occur when combining signals to provide a transmission beam at different tilt angles to be recombined in order to minimize overall losses at different tilt angles.

General Architecture

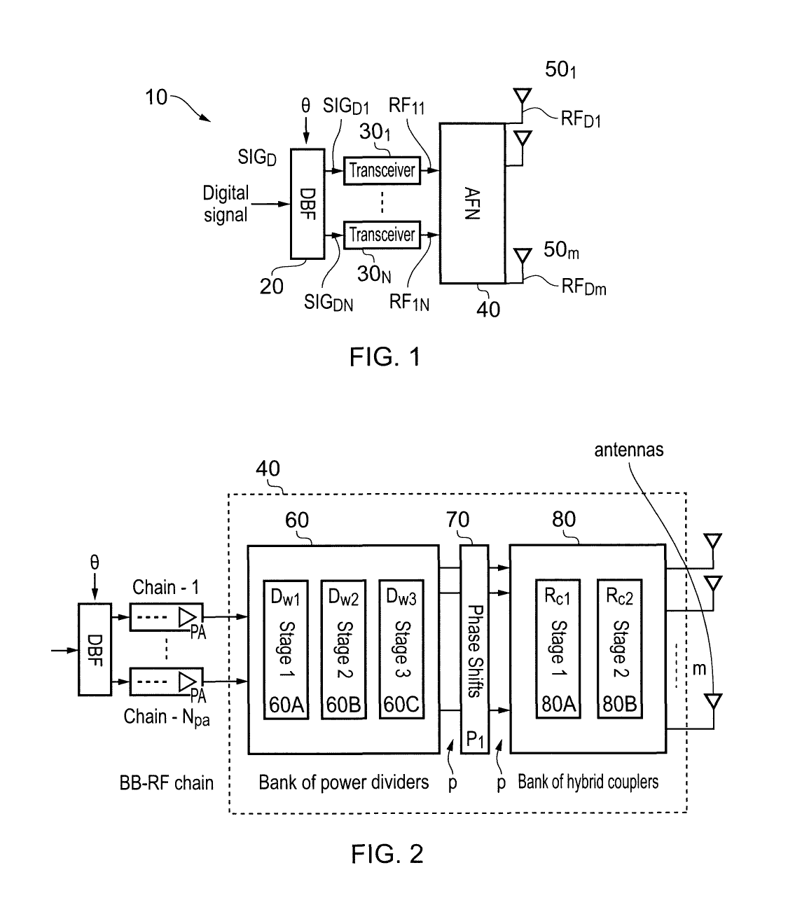

FIG. 1 illustrates the general architecture of the antenna feed, generally 10, according to one embodiment. A digital signal SIG_{D} is provided to a digital signal processor 20. The digital signal SIG_{D} is a broadband signal provided by a telecommunications network (not shown). Also provided to the digital signal processor 20 is a desired tilt angle θ. It will be appreciated that the desired tilt angle θ may be encoded in the digital signal SIG_{D}.

The digital signal processor 20 generates a broadband digital signal SIG_{D1} to SIG_{DN}, one for each transceiver 30₁ to 30_{N}. Each broadband signal SIG_{D1} to SIG_{DN} has a differing amplitude and phase shift, depending on the tilt angle θ.

Each transceiver 30₁ to 30_{N} generates an RF signal RF₁₁ to RF_{1N}, which is provided to an antenna feed network 40. The antenna feed network 40 generates an increased number of RF signals therein and then combines these signals to generate a signal RE_{O1} to RF_{OM}, each of which is provided to an associated antenna 50₁ to 50_{M}. Typically, the number M of antennas exceeds the number N of transceivers.

Accordingly, this architecture uses a radiofrequency antenna feed network to connect a reduced number of transceivers with an increased number of antennas. Different instantiations of this arrangement provide the required beam pattern, sectorisation and sidelobe levels which are typically only seen with arrangements where a dedicated and separate transceiver chain is provided for each antenna within the antenna array.

Antenna Feed Network

FIG. 2 illustrates schematically the arrangement of the antenna feed network 40 according to one embodiment. The antenna feed network 40 feeds signals from each transceiver 30₁ to 30_{N} to a set of antennas 50₁ to 50_{M}. Antenna feed network 40 can be broadly decomposed into 3 RF filter banks, depending on the primary function of each bank. In particular, the antenna feed network 40 comprises a bank of power dividers 60 coupled with a bank of phase shifters 70 which, in turn, is coupled with a bank of hybrid couplers 80.

Each of the banks may be characterized into one or more multiple stages. For example, the bank of power dividers 60 is characterized into ₃ stages 60A, 60B, 60C. Stage 60A receives the signals from the transceivers 30₁ to 30_{N} and generates an increased number of RF signals. This increased number of RF signals is provided to stage 60B, which in turn generates an increased number of RF signals and provides these to stage 60C. Generally, the bank of power dividers 60 generates P RF signals, where P is greater than N and greater than M.

Each of these P signals is provided to the phase shifters 70, which provides interconnecting wires to reorder the sequence of the signals received from the bank of power dividers 60 and applies a required phase shift to each of those signals. The bank of phase shifters 70 outputs P RF signals to the bank of hybrid couplers 80.

The bank of hybrid couplers 80 recombines some of these RF signals together. The bank of hybrid couplers are typically directional/hybrid couplers. The recombination of the signals provides M output signals RF_{O1} to RF_{OM}, one for each antenna 50₁ to 50_{M}. In particular, the bank of hybrid couplers 80 contains a first stage 80A which receives the signals from the bank of phase shifters 70 and provides a reduced number of RF signals to the second stage 80B. Any losses which occur from the recombining of signals at the first stage 80A are fed to the second stage 80B for combining with other signals in order to reduce losses at different tilt angles.

This architecture provides a simplified, reduced mass and reduced power consumption approach to provide adaptive beamforming of the transmission beam transmitted by the antenna array. It will be appreciated that the phase shifts applied by the digital signal processor 20, the power division ratios applied by the bank of power dividers 60, the interconnects and phase shifts applied by the bank of phase shifters 70 and the signals to be coupled to reduce losses by the bank of hybrid couplers 80 may be calculated in any number of different ways, however, Annex A describes a particularly efficient approach to generating these parameters.

The amplitude and phase of the RF signal output by each transceiver 30₁ to 30_{N} is different for different sectorisation tilt angles. Any static RF network coupled with these signal will result in losses whenever the input signals are not matched. Thus the feed network 40 must be designed such that its final stage accounts for overall losses in the network and provides compensation. Accordingly, this means that the bank of hybrid couplers 80 should be provided at the last stage of the antenna feed network 40. In order to achieve a desired beam shape at the array, the phase shifter network 70 is utilised in combination with the digital signal processor 20. Given that the array size is much greater than the number of transceivers 30₁ to 30_{N}, the phase shift network 70 needs to operate on signals divided from those provided by the transceivers 30₁ to 30_{N}; to compensate for insertion losses, these need to be placed before the bank of directional couplers. In order that the bank of phase shifters 70 gets the signals divided from the transceivers 30₁ to 30_{N}, the bank of power dividers 60 therefore needs to be connected to the transceivers 30₁ to 30_{N}. Accordingly, it can be seen that the ordering of the different banks within the antenna feed network 40 should follow that ordering described above.

Hence, it can be seen that the antenna feed connects a reduced number of transceivers [typically to 3 or 5] to an array with an increased number of antennas [typically 10 to 14]. The transceivers contain adaptive beamformers, and in combination with the feed network and the antenna array, generate the desired beam to satisfy the coverage and capacity requirements of most, for example, macro cell wireless networks. In particular, the feed network is a fixed beam former and in combination with the transceivers and digital signal processor achieves adaptive beamforming. Subsequently, the adaptive beamforming leads to sectorisation and enhanced coverage at a fraction of the complexity and cost of arrangements where a separate transceiver chain is provided for each antenna.

Power Dividers

The function of the bank of power dividers 60 is to distribute the transceiver power amplifier outputs RF_{I1} to RF_{IN} with the appropriate power ratios towards multiple antennas. Each bank of power dividers is typically made of multiple stages of Wilkinson power dividers and each stage of power dividers comprises at least N Wilkinson power dividers. The power dividers used in this embodiment are 3-port networks, with 1 input and 2 outputs. Each of these dividers are designed to be either a balanced divider [providing a 3 dB ratio at each output] or an unbalanced divider.

Typically, the number of stages of power dividers is limited to 3 in order to minimize the overall losses in the network. To achieve a specific beam pattern, each signal RF_{I1} to RF_{IN} is divided into 2 signals using a Wilkinson divider at stage 60A. This action is repeated subsequently at each stage such that the power divided signals output by the bank of power dividers and their power ratios enable the required beam patterns at different tilt angles.

### Bank of Phase Shifters

The function of the bank of phase shifters 70 is to shift the phase of the power divided signals to achieve the desired beam shape. The output of the bank of power dividers 60 is connected to a set of phase shifters [for example, transmission lines, micro-strip lines or other phase shifting devices]. The length of these lines is dictated by the phase shifts required, which in turn is estimated to achieve specific beam patterns.

The bank of phase shifters 70 also contains an interconnecting matrix of wires. The function of the interconnecting matrix of wires is to ensure that the rest of the network has no requirement for any further crossovers or interconnects and to ensure that the overall number of crossovers and interconnects in the entire network is reduced to a minimum.

Bank of Hybrid Couplers

The function of the bank of hybrid couplers 80 is to couple the phase shifter bank 70 with the antenna array to provide beamforming and sectorisation while minimizing overall losses in the network. It will be appreciated that insertion losses occur in a feeding network when signals of unequal amplitude and phase are input to a coupler. These losses limit the performance of the entire architecture. The primary objective is to minimize the losses in the overall network for different sectorisation tilt angles.

The bank of hybrid couplers 80 is typically made of 2 stages of hybrid couplers followed by one stage of Wilkinson combiner. Each stage of hybrid coupler has less than N hybrid couplers of the rat-race type. The rat-race coupler is a 4-port network with 2 inputs and 2 outputs. The 2 outputs computes the sum [in phase] and difference [out of phase] of the input signals from the transceivers [via the bank of power dividers 60 and the bank of phase shifters 70]. Depending on their phase and amplitude, the difference output extracts the losses in the overall network. The antenna feed network 40 is designed such that the coupler outputs are rerouted in the next stage to achieve the desired tilt angle and beam pattern.

Accordingly, it can be seen that the antenna feed network 40 is designed as a multichannel linear phase filter. In such filters, the losses in the network can be extracted from the difference port. This design technique allows the design of multiple stages of network that minimizes losses in the overall network.

### EXAMPLE 1

### 11 Antennas and 2 Transceivers

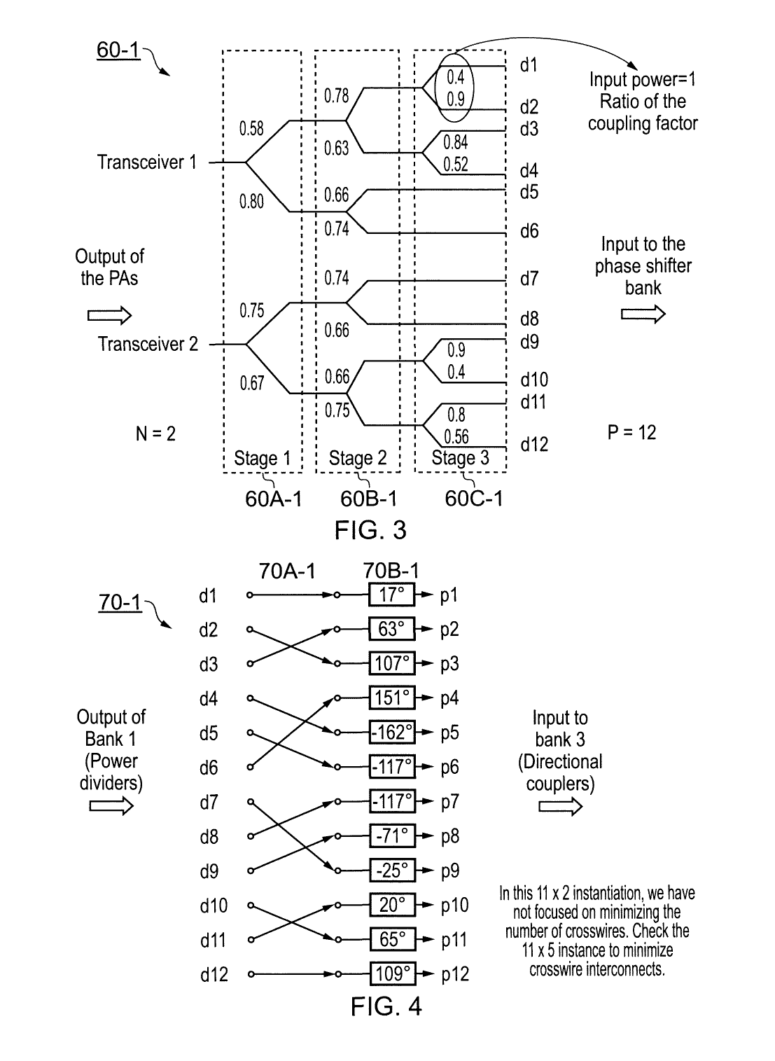

A first example antenna feed is shown in FIGS. 3 to 5. This arrangement utilizes signals from 2 transceivers connecting with 11 antennas and is intended to provide 16 dB sidelobe suppression with a dynamic downtilt range of 6 to 7°, 3 dB beam width of 4°. The design has the following constraints: power dividers where the power ratio is less than 4 dB; the number of divider and coupler stages is limited to 3.

As can be seen in FIG. 3, the bank of power dividers, generally 60-1, comprises 3 stages 60A-1 60B-1, 60C-1. The first stage 60A-1 receives the outputs of the transceivers [not shown] and in this case, N equals 2.

The first stage 60A-1 comprises 2 3-port Wilkinson dividers. Stage 60B-1 comprises 4 3-port dividers. Stage 60C-1 comprises 4 3-port dividers. As can be seen, all the power dividers are unbalanced. The amplitude tapering introduced by the unbalanced dividers leads to improved sidelobe suppression. The power divide ratios illustrated are root mean square [RMS] ratios. The output of the bank of power dividers 60-1 is provided to the bank of phase shifters 70-1. In this example, P equals 12.

FIG. 4 illustrates an arrangement of the bank of phase shifters 70-1. The bank of phase shifters 70-1 receives the output signals from the bank of power dividers 60-1. An interconnect arrangement 70A-1 is provided. The crossovers in this part of the circuit ensure that there are no other crossovers in other parts of the antenna feed. The outputs from the bank of power dividers 60-1 are phase shifted by the angles specified and provided to a bank of hybrid couplers 80-1. Such an arrangement makes it easier to optimize the overall circuit for the number of crossover connections.

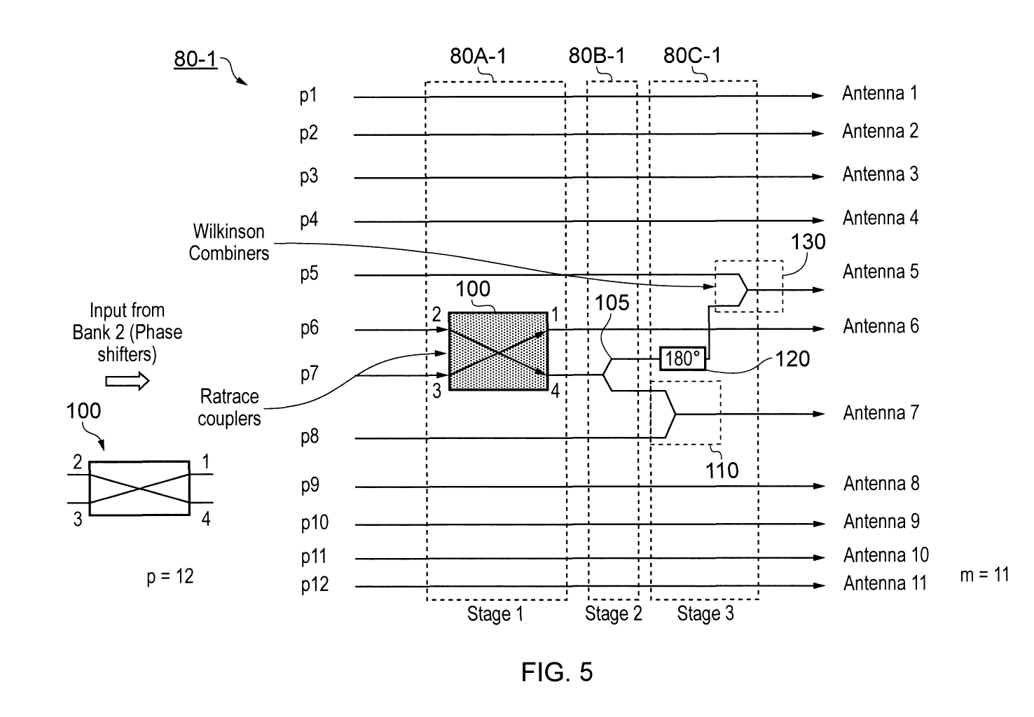

FIG. 5 illustrates a bank of hybrid couplers 80-1. The bank of hybrid couplers 80-1 receives the outputs from the bank of phase shifters 70-1 and produces a signal to be fed to each of the antennas. In this example, M equals 11.

As can be seen, the phase shift outputs P6 and P7 are input to ports 2 and 3 of a rat race coupler 100. The output of the sum port 1 is connected to the antenna 6. The output of the difference port 4 is divided into 2 using a power divider 105, one output is combined with phase shift output P8 [using a Wilkinson combiner 110] and connected to antenna 7. Another output of the power divider is connected via a 180° phase shifter 120 with the phase shift output P5 [using a Wilkinson combiner 130] and connected to antenna 5.

As mentioned above, losses occur in when the amplitude and phase weights at the input ports 2 and 3 of the directional coupler 100 are not matched. This scenario occurs when the digital signal processor weights are modified to provide vertical sectorisation at different tilt angles. In this case, port 4 of the rat race coupler 100 extracts the insertion loss. The feed network satisfies the linear phase property and the phase of the signal at port 4 of the coupler 100 will be equal to the phase at phase shift output P8 and 180° from the phase shift output P5. Thus the insertion loss is routed towards antennas 5 and 7 to achieve the desired beam pattern and minimize the overall losses in the network.

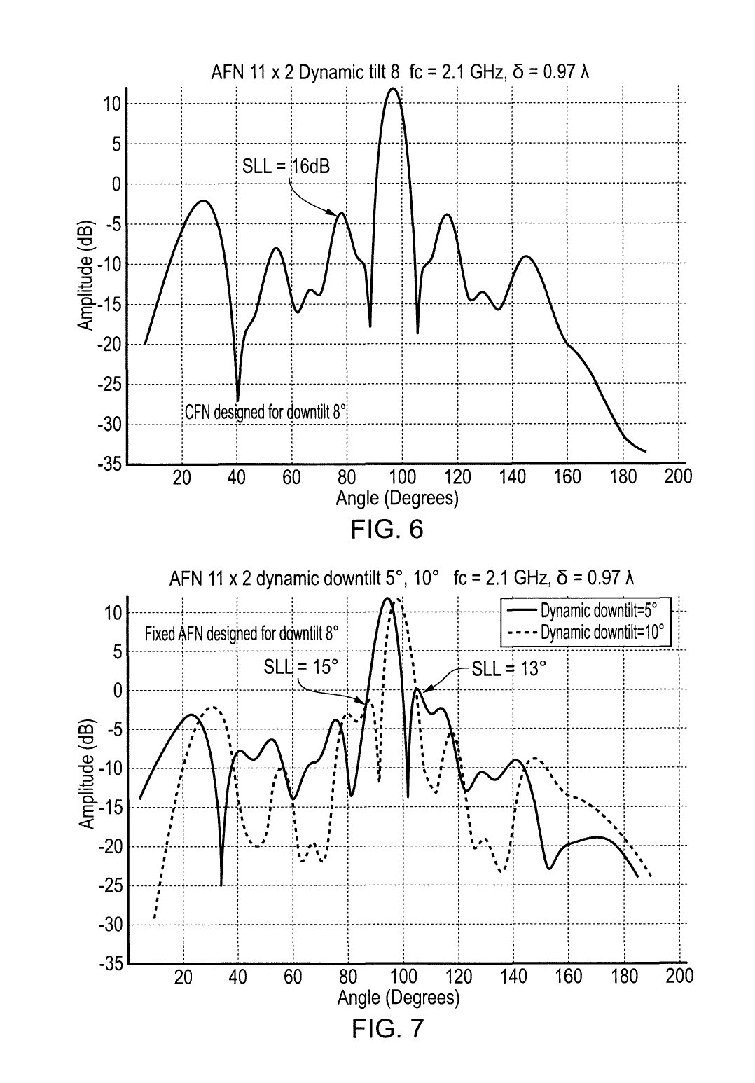

FIG. 6 illustrates the performance of the antenna feed of FIGS. 3 to 5 with a static downtilt of 8°. The feed network is used in combination with 2 digital beamformers taps [0-2 dB attenuation and 0-360° phase shifts] and provides 16 dB sidelobe levels.

FIG. 7 shows the performance of the antenna feed under dynamic downtilt of 5 and 10°. The arrangement of the antenna feed is unchanged and the digital beamformers weightings are modified to tilt the beam towards specific sectors. In this example, a sectorisation of dynamic downtilt of 10° with 16 dB sidelobe levels is achieved. Similarly, a sector at downtilt 5° results in 13 dB sidelobe levels. For both of these sectors, the required 3 dB beamwidth of 5·4° and maximum energy towards the main lobe is achieved. Since the number of transceivers is 2, the digital beamformers has reduced degrees of freedom and the downtilt range is less than or equal to 7°. As the number of transceivers increases, the range of downtilts significantly increases as will now be described below.

### EXAMPLE 2

### 11 Antennas and 5 Transceivers

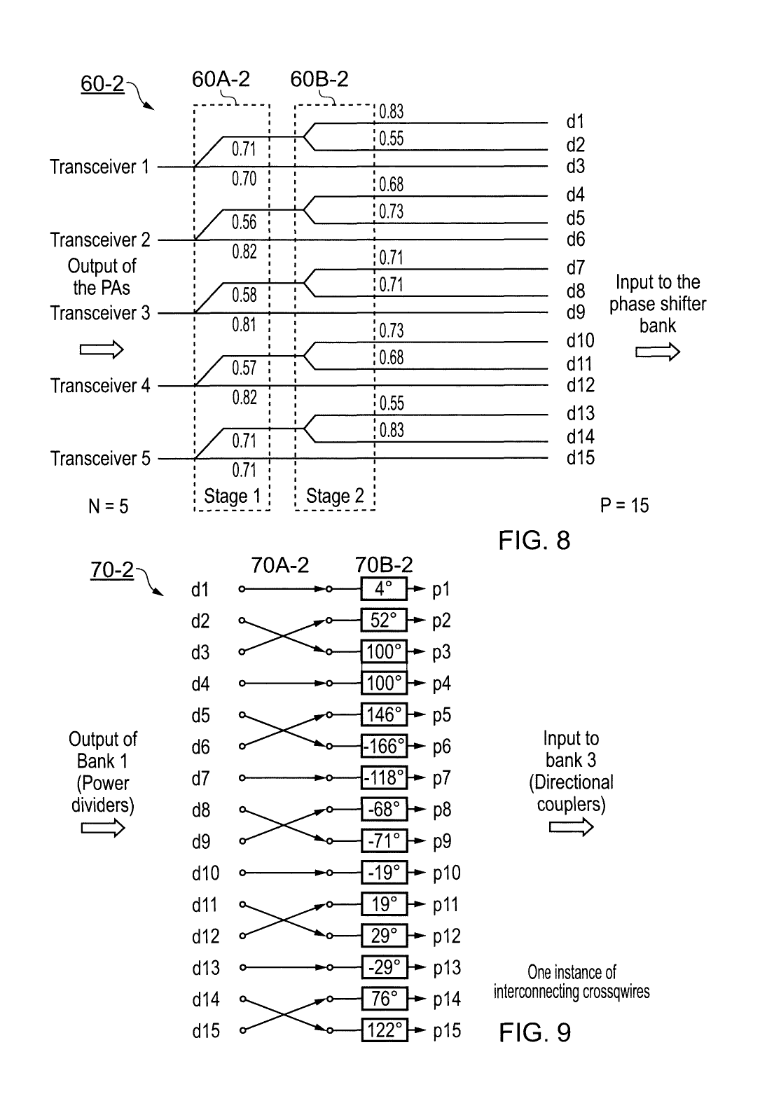

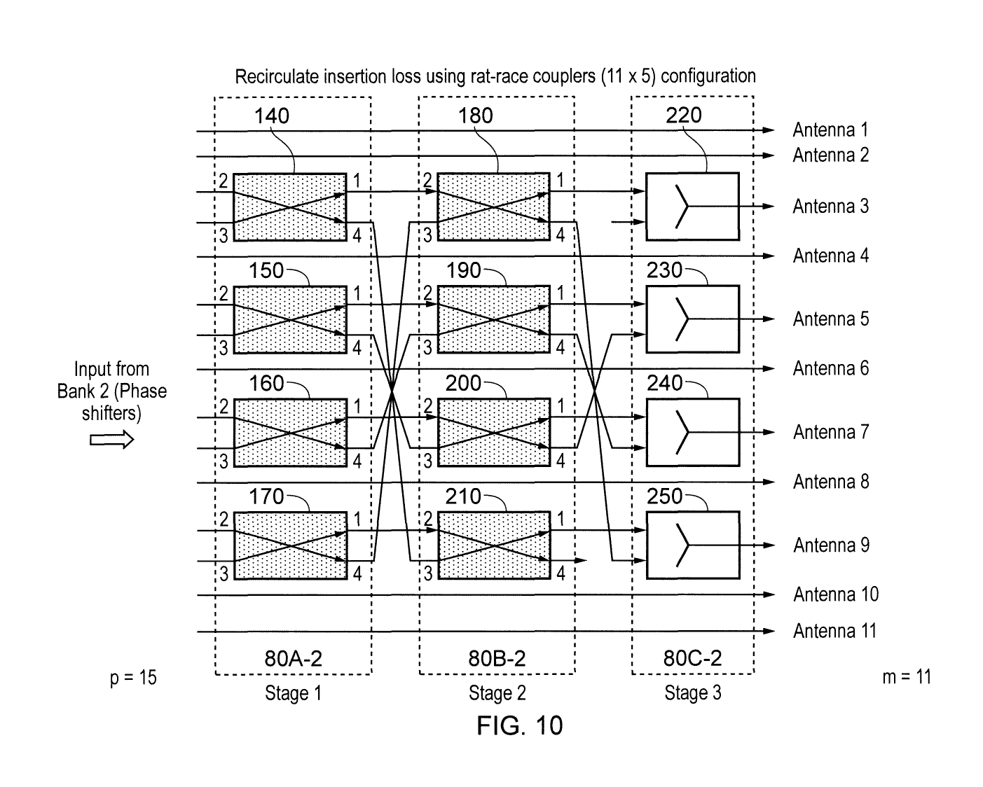

FIGS. 8 to 10 illustrate an antenna feed using ₅ transceivers connected to 11 antennas and designed to minimize insertion losses. The antenna feed is intended to achieve 16 dB sidelobe levels with a dynamic downtilt range of 12°, together with a 4° 3 dB beamwidth along the desired sector while minimizing the insertion losses. The arrangement is constrained to have power dividers with power ratios of less than 4 dB and the number of divider and coupler stages less than 3.

As shown in FIG. 8, the outputs from the transceivers [not shown] are provided at the first stage 60A-2 of a bank of power dividers 60-2 where they are power divided. The outputs of the stage 60A-2 are provided to the second stage 60B-2. In this example, the bank of power dividers 60-2 comprises 2 stages. The first stage 60A-2 comprises 5 3-port Wilkinson dividers, whilst stage 60B-2 comprises 5 3-port dividers. The output of the bank of power dividers 60-2 is provided to a bank of phase shifters 70-2. In this example, P equals 15.

FIG. 9 illustrates the bank of phase shifters 70-2. The bank of phase shifters receives the outputs from the bank of power dividers 60-2. An interconnect region 70A-2 redistributes the ordering of the signals provided to the phase shifters 70B-2. The phase shifters 70B-2 perform a phase shift on each of the received signals. Typically, such shifts in phase are achieved using standard micro-strip-based transmission lines, with the length of the line corresponding to the phase shift desired. However, it will be appreciated that other arrangements of phase shifters may be provided. The output from the bank of phase shifters 70-2 is provided to a bank of hybrid couplers 80-2.

The bank of hybrid couplers 80-2 comprises 3 stages. In the first stage 80A-2, the phase shifter outputs P3 and P4 are input to ports 2 and 3 of the rat race coupler 140. Similarly, phase shift outputs P6 and P7, P9 and P10 and P12 and P13 are input to ports 2 and 3 of the corresponding rat race couplers 150, 160, 170.

In the second stage 80B-2, the output of the sum port 1 of the coupler 140 and the difference port 4 of the coupler 170 are fed as inputs to a second stage rat race coupler 180. Similar inputs are provided to each of the other second stage race couplers 190 to 210.

The output of the sum and difference ports of the second stage rat race couplers 180 to 210 are subsequently combined with a Wilkinson combiner 220 to 250 in the third stage 80C-2 and connected with an appropriate antenna.

As mentioned above, each rat race coupler provides at its port 4 the insertion loss in the coupler. Insertion losses occur due to a mismatch in amplitude and phase. For an arrangement where the impedances are matched, the insertion losses occur due to unequal phase shifts. It should be noted that the phase progression of the antenna feed is linear. Thus, the isolation signal from the difference ports 4 provides a measure of the phase correction required at the antennas 3, 5, 7 and 9 to achieve the desired beam pattern. Recirculating and combining this phase correction in stages 2 and 3 reduces the insertion losses and ultimately results in optimal beam patterns.

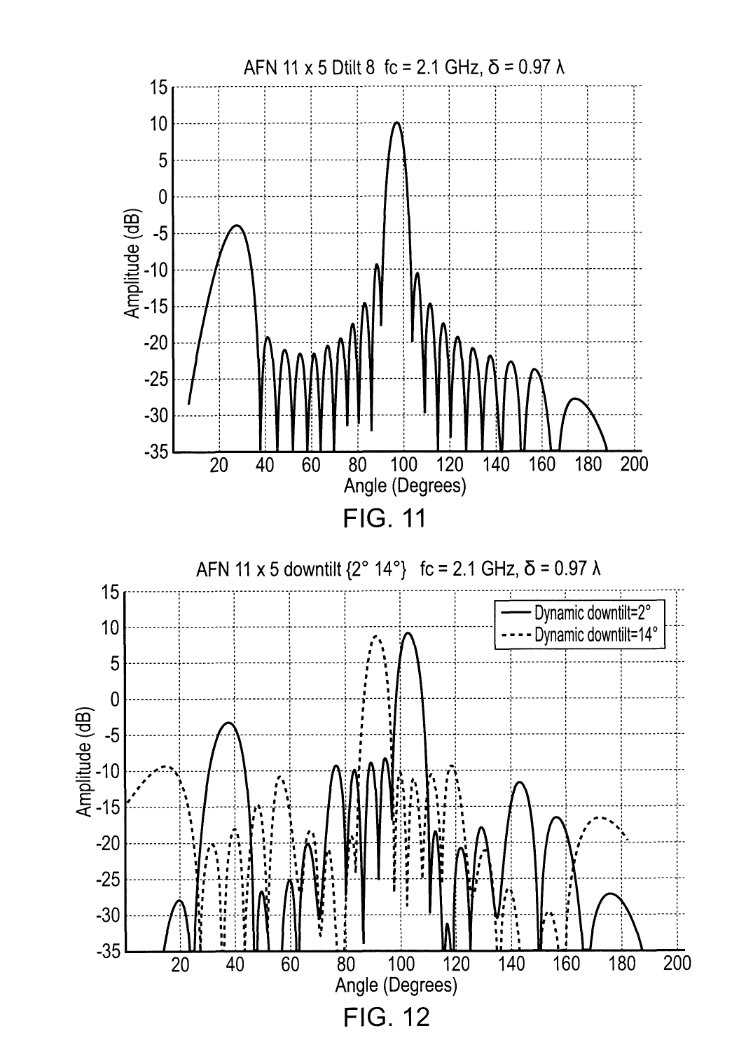

FIG. 11 shows the performance of the antenna feed shown in FIGS. 8 to 10 with a static downtilt of 8°. The antenna feed is used in combination with 5 digital beamformers taps [0-2 dB attenuation and 0-360° phase shifts] and provides 22 dB sidelobe levels at a downtilt of 8°.

FIG. 12 illustrates the performance with a dynamic downtilt of 2 and 14°. The antenna feed is unchanged and the digital beamformer's weights are modified to tilt the beam towards specific sectors. In this case, a sectorisation dynamic downtilt of 14° with 19 dB sidelobe levels is achieved. Similarly, a sector at downtilt of 2° results in 18 dB sidelobe levels. For both of these sectors, the required 3 dB beamwidth of 4.5° and maximum energy towards the main lobe is achieved.

Accordingly, it can be seen that a factor of 2 or more in the reduction in costs and the number of active components for active antenna architectures can be achieved. This arrangement improves the performance of the antenna array even under partial failure of the transceivers. The generic factorization allows for fast generation of solutions for specific antenna feed requirements.

Antenna Feed Design

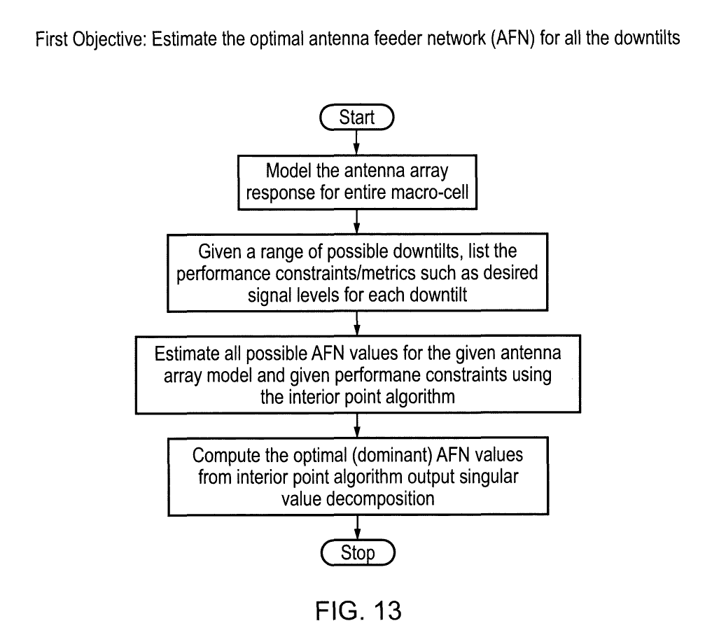

FIGS. 13 to 16 illustrate the general method steps for arriving at a particular antenna feed design. More details on the exact methodology used can be found at Annex A. It will be appreciated that this methodology can be implemented dynamically to provide for dynamic redesign of the antenna feed in-situ using, for example, microelectromechanical systems (MEMS) technologies.

FIG. 13 illustrates the method steps which estimate the optimal antenna feed network for all possible downtilts. However, this approach is not necessarily suitable to minimize insertion losses.

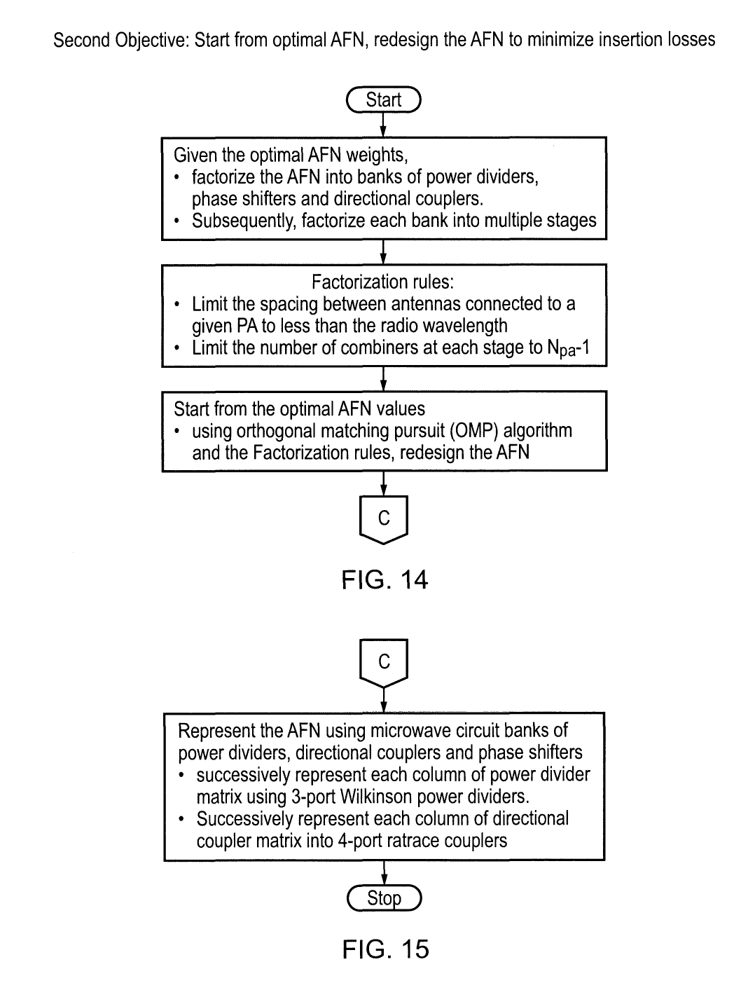

FIGS. 14 and 15 illustrate the method steps which uses the optimal antenna feed network estimated in FIG. 13 and redesigns the antenna feed network to minimize insertion losses.

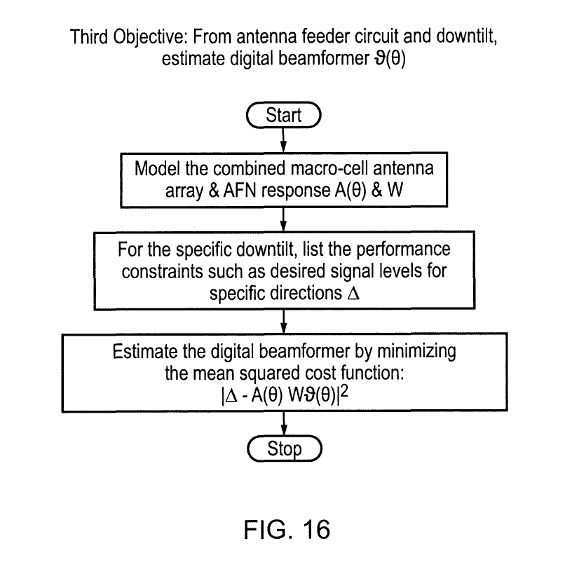

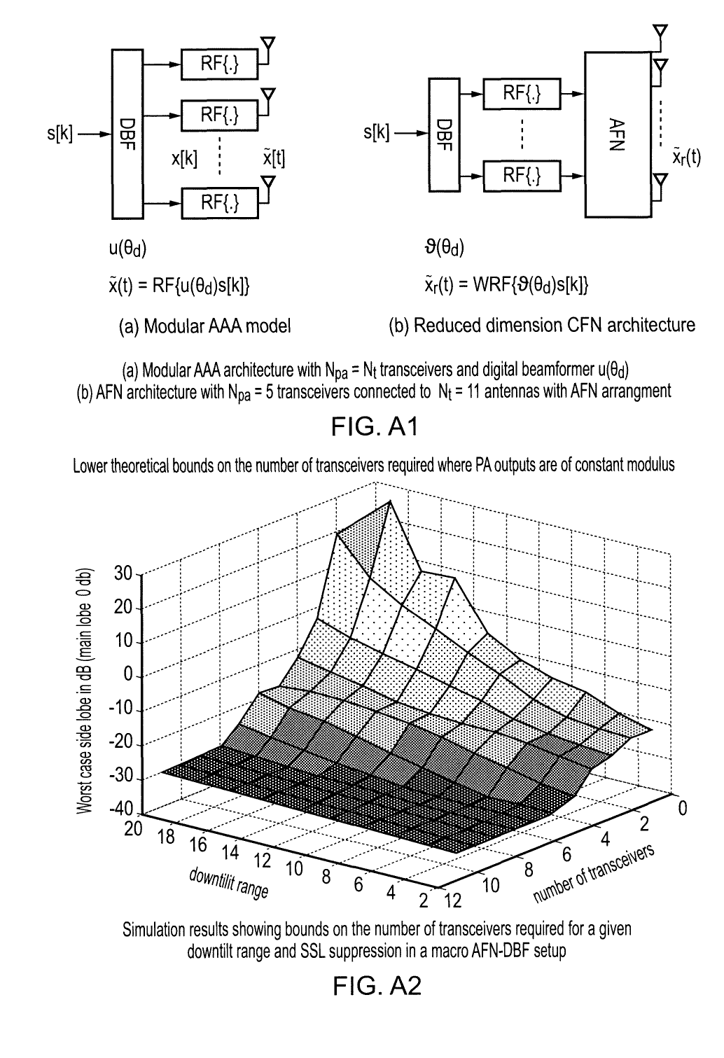

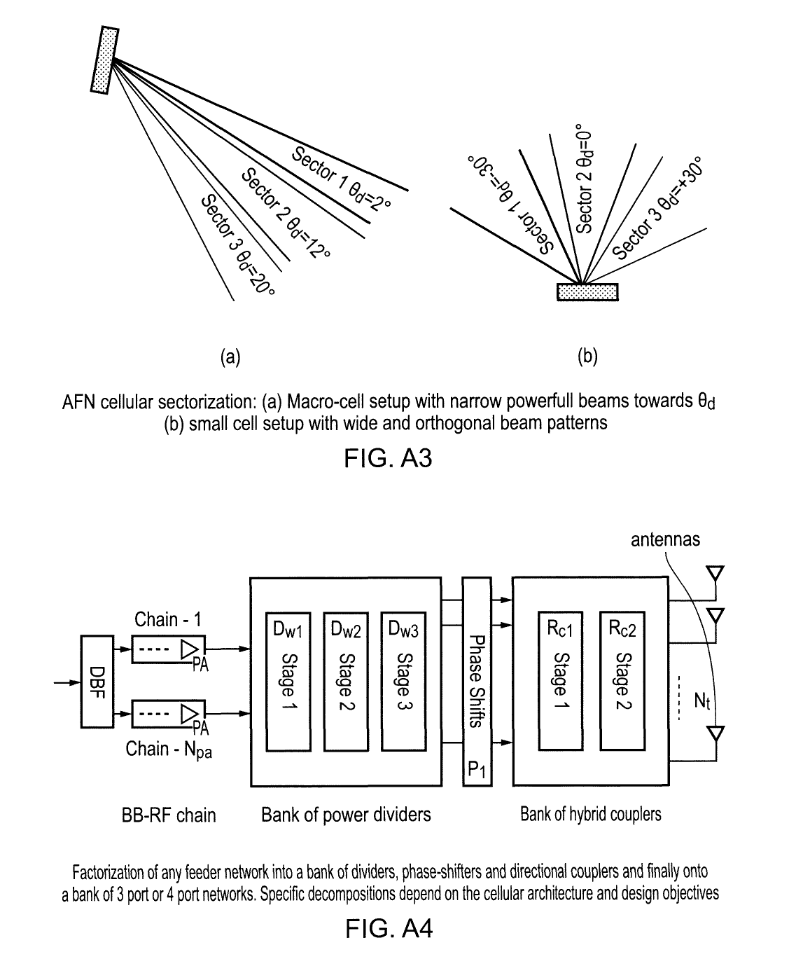

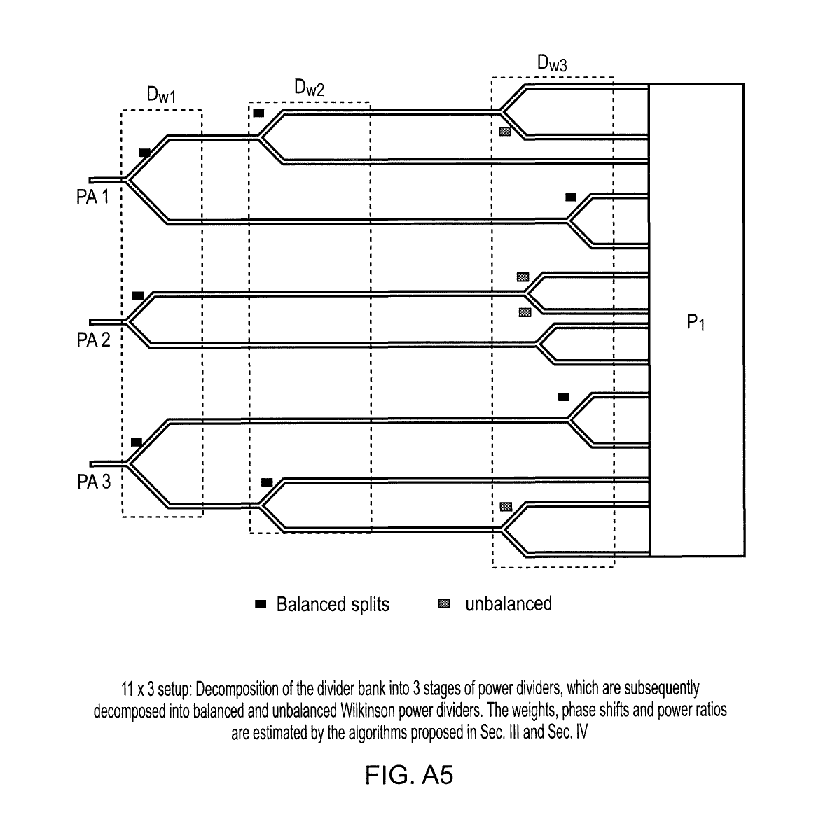

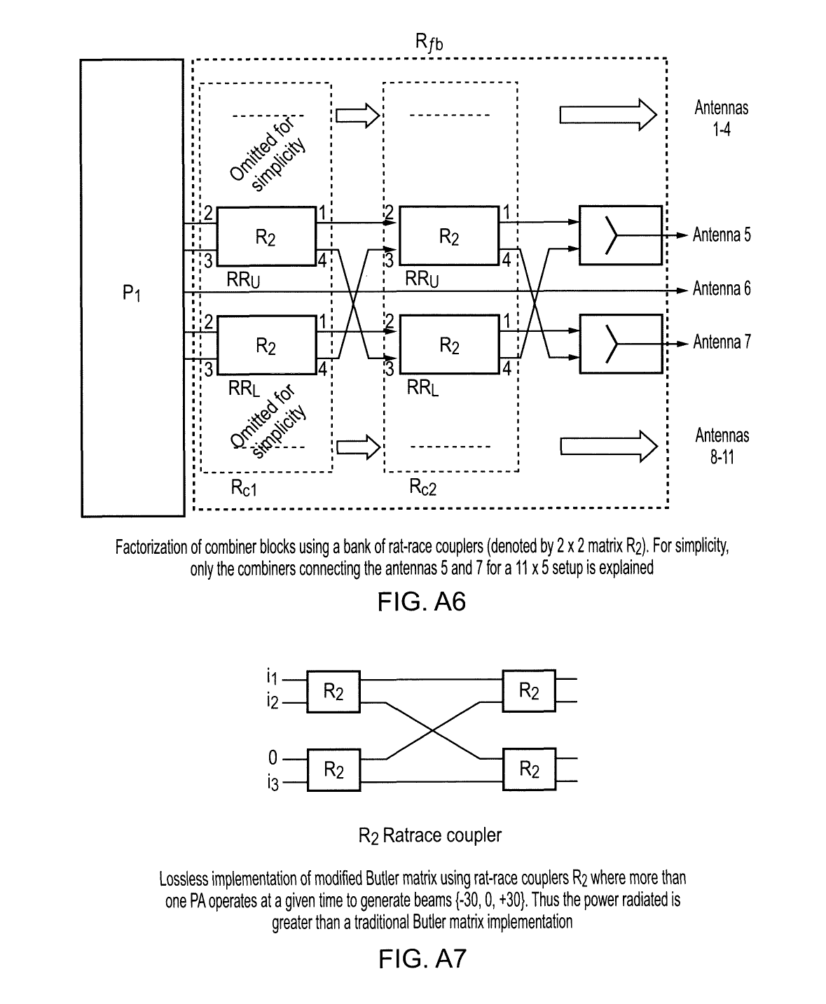

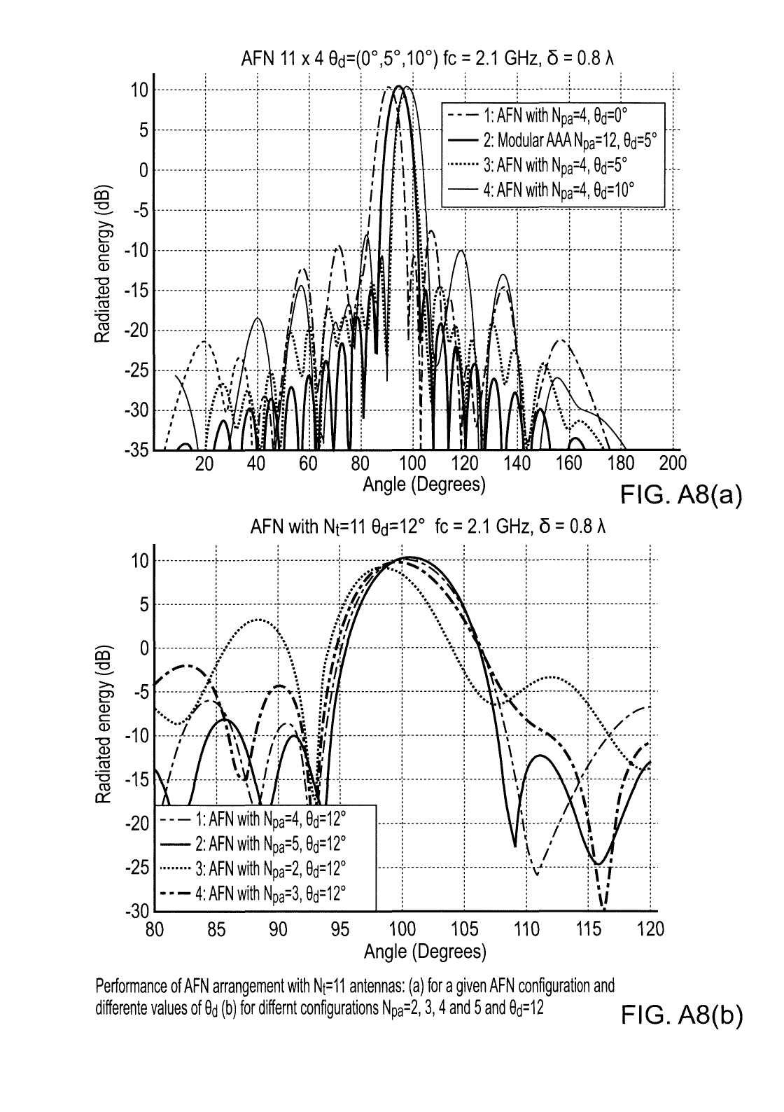

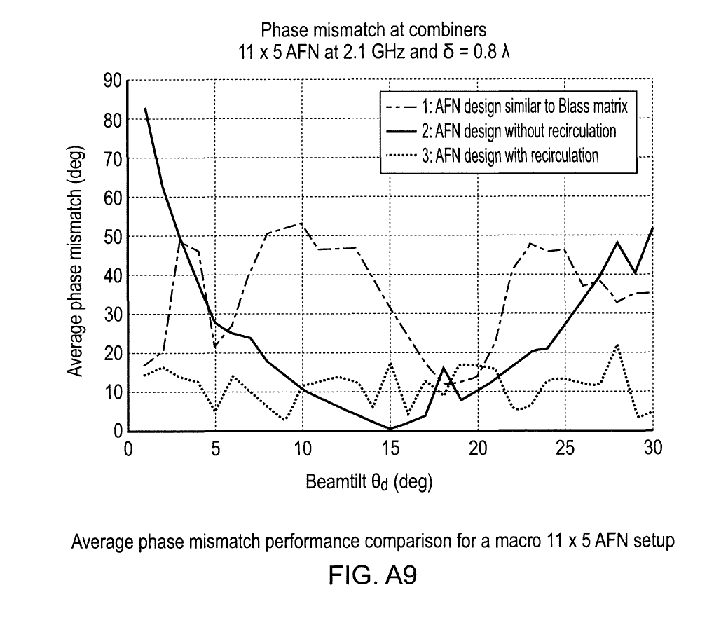

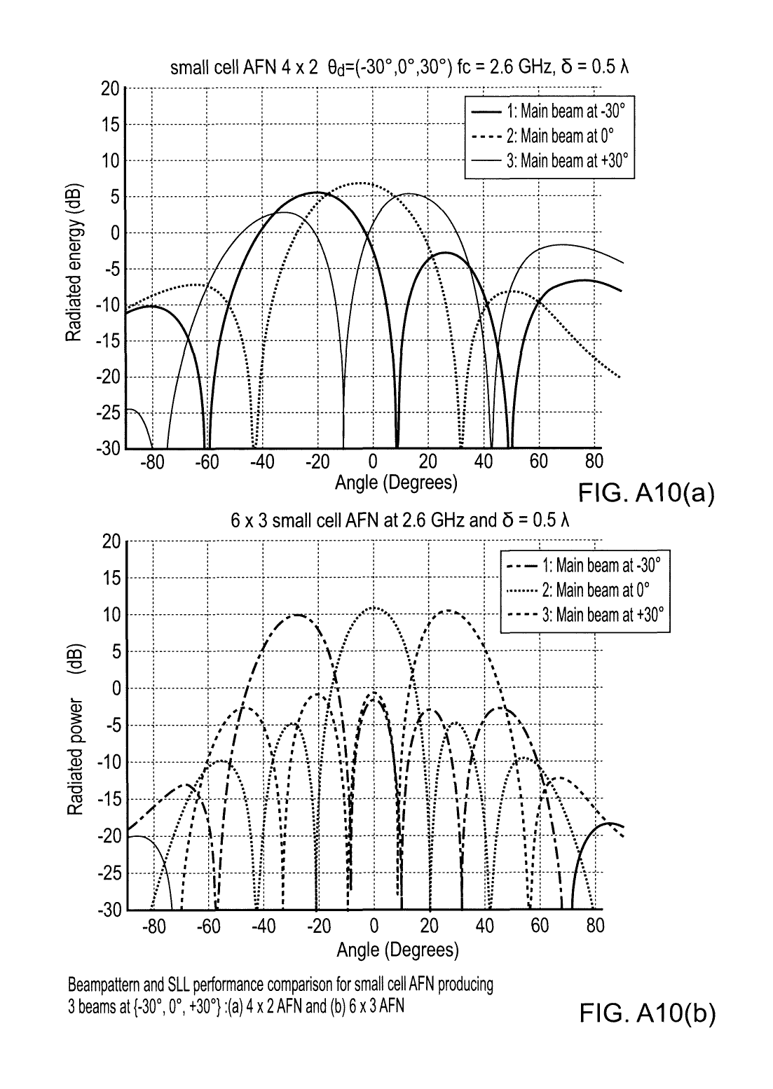

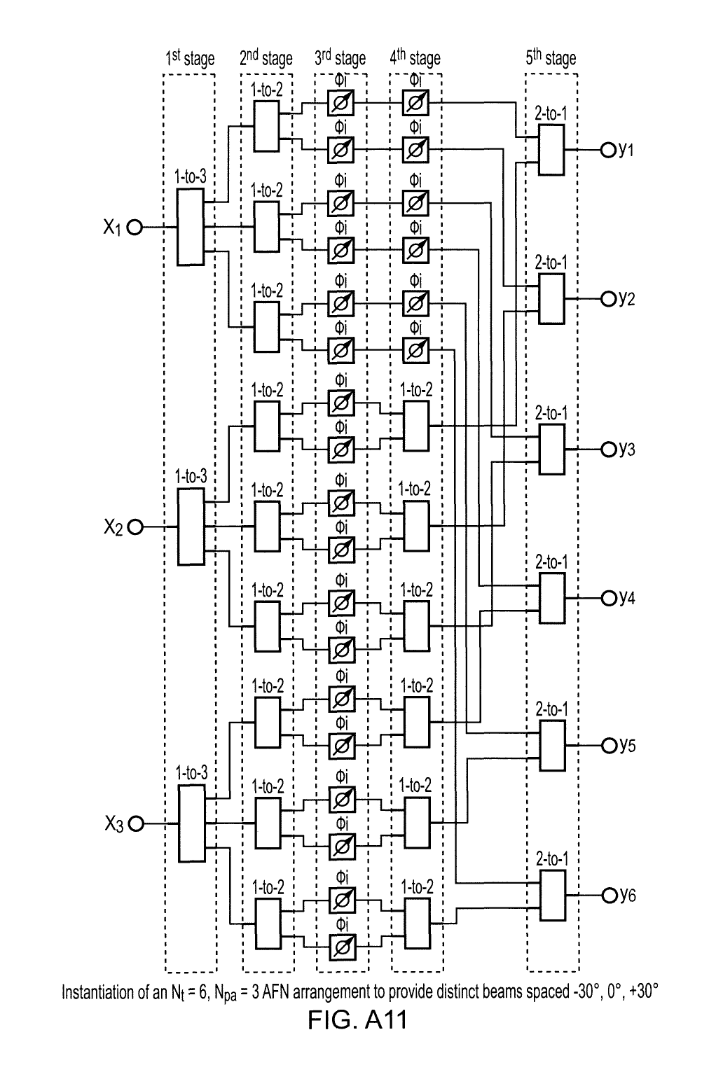

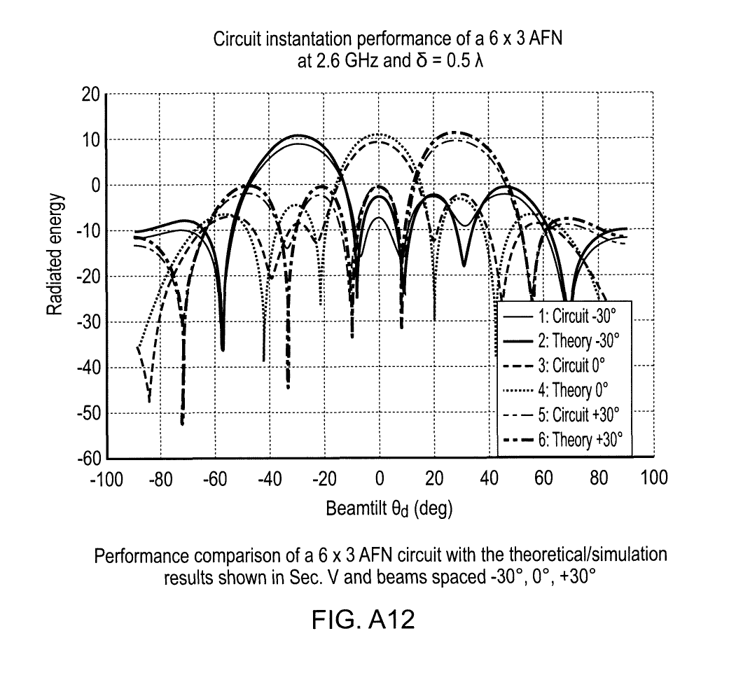

FIG. 16 illustrates the method steps which utilize the redesigned antenna feed network and required downtilt to estimate the parameters for the digital beam former.

Annex A—Detailed Antenna Feed Design

### Joint Optimization of RF Feeder Network and Digital Beamformer in Reduced Dimension Active Wireless Transceivers

Multi-output systems with digital beamforming can lead to significant improvements in capacity and signal coverage of cellular communication systems. Typically, these systems have an active transceiver connected to each antenna and provide the flexibility to adaptively beamform/multiplex the signal. However, the set of active transceivers also significantly increases the scale and the cost of a large scale antenna array system. We propose a partially adaptive beamformer setup where a reduced number of transceivers with digital beamformers (DBF) are connected to an increased number of antennas through a RF antenna feeder network (AFN).

Given this architecture, we present a methodology to estimate the minimum number of transceivers required for different cellular base-stations. We propose algorithms to jointly design the DBF and AFN weights providing relevant beam patterns, while satisfying a host of performance and operational constraints. Subsequently, we consider the practical limitations in the design of such networks and factorize the AFN using microwave components. Finally, we provide instances of the AFN for macro-cell and small cell scenarios, highlighting the similarities and differences between the theoretical bounds specified by the algorithms, and simulation results specified by the architectures as well as their practical instantiations.

### I. Introduction

### A. Prior Work and Objective

Next generation wireless networks will employ multiple active transceivers or active antenna arrays (AAA) at cellular base stations to achieve reliable communication close to theoretical limits [1]. Such an array of active antennas used in combination with macro and smaller cell architectures would allow adaptive sectorization of signals towards specific users as well as increased co-ordination between different cellular base-stations, ultimately resulting in energy efficient transmission. However, the introduction of multiple transceivers at the transmitter also significantly increases the cost of the radio frequency (RF) front-end.

Consider a multi-antenna transmitter setup, where each antenna is connected to a dedicated RF chain and a baseband transceiver. Although adaptive beamforming techniques are commly used [2], such systems will cause a significant drain on the capex and opex of any given cellular base-station. Falling-back to a passive remote radio head would force us to abandon on all the achievable benefits seen using a AAA setup. This research comprehensively explores all possible ways to map reduced number of transceivers to increased number of antennas. Our underlying objective is to come up with a list of architectures that allows the required flexibility provided by the AAA at a fraction of the capital.

We consider a setup where the transmit signals are adaptively beamformed in digital domain, converted from the baseband to RF using a set of Nₚₐ RF chains/transceivers. These RF signals are subsequently connected to Nₜ antennas using a Nₜ×Nₚₐ, Nₜ>>Nₚₐ antenna feeder network (AFN) as shown in FIG. A1(b). Analog beamforming architectures with reduced number of RF chains have been previously proposed for low-power transceivers [3]. However, for a radiated power greater than 30 dBm (as required in cellular base-stations), it is impossible design adaptive RF circuits, varactor diodes etc. This fundamental limitation restricts RF feeder networks to a space of fixed beamforming networks/matrices connecting transceivers/PAs and antennas. A phased array system for (Nₜ=10) with a single transceiver and electrical tilt arrangement has been shown in [4], [5]. Such approaches have a network of microwave components such as directional couplers, power dividers and phase shifters to achieve desired the desired electro-mechanical/electrical beam tilts. These systems are inherently limited by the range of downtilts, poor performance, losses in the network as well as the flexibility of the setup.

Our aim in the paper is to design the optimal feeder networks and digital beamformer (DBF) weights for different cellular architectures. Our design focus varies for various cellular architectures. In a macro-cell setup, the focus is to provide a highly directive beam and minimize losses in the feeder network while satisfying the sidelobe levels (SLL) and dynamic range of the PAs for different sectors. In a small-cell or metro-cell setup, the focus is to optimize for orthogonal beam patterns and SLL, while sacrificing on the losses in the feeder network. Some design issues are (1) to choose Nₚₐ for a different sets of downtilt range and (2) to select the AFN components and DBF weights satisfying SLL and PA constraints and (3) to determine the factorization stages in the AFN.

### B. Connections

In the array signal processing literature, several types of RF preprocessors have been designed to reduce the dimensions of receiver chains and minimize power consumption [6], [7]. These techniques are grouped under “beamspace processing” and provide a systematic approach to design a beamformer optimizing a data mdoel for a given cost function. However they do not take the practical limitations/constraints or realize such networks in practice.

Alternatively [8], [9] design microwave components and networks that enable RF beamforming. In these networks, the emphasis is more on the practical design of such networks. Subsequent work such as [10] establish possible signal processing framework to design feeding networks. This work acts as a bridge between the theoretical and practical sides of the antenna array design. In the current transaction, we start from a signal processing/optimization perspective, however we include the performance restrictions as well as the network limitations to come up with a comprehensive synthesis and analysis of several feeder network configurations

### C. Contributions and Outline

In this paper, we progressively study various aspects of feeder network design. In Sec. II, we specify the data model and formulate the design problem. In Sec. III, we provide theoretical bounds for minimum number of transceivers and their relation with downtilt range and SLL. Subsequently, we propose algorithms to design the optimal weights of RF AFN and DBF, while considering the performance constraints and PA limitations.

In Sec. IV, we consider macro and small cell scenarios, and factorize the AFN into a bank of power dividers and directional couplers. The focus of this factorization depends on the specific cellular scenarios and whether to optimize AFN for a list of beam patterns or to minimize for losses in the AFN. We generalize such architectures to Butler-like matrices, and show the family of architectures and the required conditions to optimize beam pattern and minimize feeder losses. In Sec. V, we provide simulation results for different flavors of the AFN and Sec. VI provides the circuit instantiation of a macro-cell and metro cell architectures with its beampattern, insertion loss and SLL performance.

Notation: Lower and upper case bold letters denote vectors and matrices. (\tilde{.}) denotes RF signals, while (.) and [.] respectively denote the analog and digital signals. (.)^{T}, (.)^{H}, (.)^{†} and ∥.∥ respectively denote transpose, Hermitian transpose, pseudo-inverse and Frobenius norm operations. I_{K} denotes an identity matrix while 0 and 1 respectively denote matrix/vectors of zeros and ones.

### II. System Model and Proposed Architecture

### A. Data Model

Consider an Nₜ×1 vector denoting the RF signal \tilde{x}(t) transmitted from the antenna array and time t. In the modular AAA setup, the digital baseband equivalent of \tilde{x}(t) is obtained by using a beamformer u(θ_{d})=[u₁(θ_{d}), . . . , u_{N}_{ₜ}(θ_{d})]^{T} on a data stream s[k] at time t=kT:x[k]=u(θ_{d})s[k]. Note that u(θ_{d}) is a Nₜ×1 vector designed to produce a mainlobe towards θ_{d}. For sake of simplicity, we denote Nₜ ‘digital to RF’ transformation blocks (denoted by RF{.}) operating x[k] to produce \tilde{x}(t) as shown in FIG. A1(a).

Alternatively, the Nₜ×1 RF signal vector \tilde{x}ᵣ(t) can also be produced using the proposed two-step AFN-DBF architecture as shown in FIG. A1(b). Consider a setup with Nₚₐ transceivers connected to Nₜ radiating elements through a passive AFN as shown in FIG. A1(b) (For instance, Nₜ=11 and Nₚₐ=5). Details of the AFN instantiations will be explained in Sections IV and V. In this case s[k] is transformed initially to an Nₚₐ×1 vector y[k] using a Nₚₐ×1 digital beamformer σ(θ_{d})=[σ₁(θ_{d}), . . . , σ_{N}_{ₚₐ}(θ_{d})]^{T} as y[k]=σ(θ_{d})s[k], followed by Nₚₐ digital to RF transformation blocks and the AFN matrix W as

\tilde{x}ᵣ(t)=W\tilde{y}(t) where \tilde{y}(t)=RF{σ(θ_{d})s[k]}. (1)

We refer to this approach as a partially adaptive beamformer, since the AFN is estimated and kept fixed at the beginning. Subsequently, the DBF σ(θ_{d}) is adaptively designed for each beamtilt. For the sake of simplicity, consider a direct line of sight environment between the base station array and the mobile user. Assuming an ideal RF to digital transformation at the receiver, the discrete time signal received at a mobile user, which is present at a direction θᵢ with respect to the base station antenna array can then be represented (ignoring the propagation delays as)

z[k]=pᵢa^{H}(θᵢ)x[k]+n[k]

where a(θᵢ) denotes Nₜ×1 antenna array response for the angle of departure θᵢ, pᵢ denotes the propagation loss incurred from the base station to the mobile user and n[k] denotes noise terms. Assuming an uniform array with equidistant elements, the antenna response and the propagation loss are modeled as per the 3GPP specifications [2] as

$$a ( {θ}_{i} ) = g ( {θ}_{i} ) [ \begin{matrix}1 \\ {e}^{j \frac{2 π}{λ} δ cos ( {θ}_{i} )} \\ ⋮ \\ {e}^{j \frac{2 π}{λ} δ ( {N}_{t} - 1 ) cos ( {θ}_{i} )}\end{matrix} ]$$

where δ is the spacing between two antennas, λ is the wavelength in meters and g(θᵢ) is the antenna characteristic [2]. For a 3GPP transmission standard, g(θᵢ) is designed for the macro and small cell scenarios to have a 3-dB beamwidth of 65° and 110° respectively.

### B. Modular AAA Architecture—Reference

As mentioned before, our objective is to reduce the number of transceivers and thereby reducing the cost and power consumed in the antenna array. Consider a modular AAA setup for reference with Nₚₐ=Nₜ transceivers and a Nₜ×1 beamforming vector u(θ_{d}) operating on ski. The performance of such a cellular setup is characterized by its coverage and capacity, as well as its ability to sector the cells depending on the location of the desired mobile user. Each sector is distinguished by the tilt angle of the main lobe θ_{d}. The performance requirement of the beamformer comprising of the gain & directivity in the direction of the main beam and the side-lobe levels (SLL) is commonly referred to as a spatial mask and denoted u N_{θ}×1 vector Δ_{d}, where N_{θ} corresponds to the resolution.

In modular AAA architecture, the objective is to design the adaptive beamformer (u(θ_{d})) for each value of θ_{d} minimizing the overall mean squared error

$${u}_{0} = arg {min}_{u ( {θ}_{d} )} ∥ {Δ}_{d} - A ( θ ) u ( {θ}_{d} ) ∥ \qquad ( 2 )$$

where A(θ)=[a^{T}(θᵢ=−π), . . . , a^{T}(θᵢ=−π) . . . , a^{T}(θᵢ=π)]^{T} is a N_{θ}×Nₜ matrix obtained by stacking the array response vectors. A well known approach to estimate u(θ_{d}) in (2) is u₀ ≈A_{d}^{†}Δ_{d} using the least squares approach [11]. However, this approach does not always lead to the optimal solution or consider the gain and SLL.

In this paper, we will include the performance and architecture constraints such as desired gain/beamwidth, SLL, PA output levels in the original cost function (2) and estimate the beamformer weights using iterative convex optimization techniques. It has been shown extensively that these optimizations will always lead to the optimal performance [11], and similar beamformers have been designed in [12], [13]. However they limit their techniques to only cover the set of performance constraints.

Details of the beamformer design for modular AAA is omitted in this section. (However they can be easily understood from the joint AFN-DBF design by denoting W=I and Nₜ=Nₚₐ). This architecture and the subsequent beamformer weights will serve as our reference design.

### C. AFN Architecture: Problem Formulation

Consider the AFN architecture as shown in FIG. A1 and the corresponding data model (1). Our aim is to jointly design the optimal AFN matrix W and the beamforming vector σ(θ_{d}) to satisfy the desired set of spectral masks (Δ_{d}). Let N_{S} correspond to the number of sectors in a given cell, with beam-tilt θ₁, . . . , θ_{N}_{_{S}}. Note that the AFN is estimated and fixed at the start of the transmission, and this partially adaptive AFN-DBF combination must satisfy the spectral masks for N_{S} beam-tilts. The problem of jointly designing {W.σ(θ_{d})} can be represented as LS fit minimizing the overall mean squared error (MSE):

$$\{ W , ν ( {θ}_{d} ) \} = arg {min}_{ν ( {θ}_{d} )} ∥ {Δ}_{d} - A ( θ ) W ν ( {θ}_{d} ) ∥ ∀ {θ}_{d} ∈ \{ {θ}_{1} , ⋯ , {θ}_{{N}_{s}} \} \qquad ( 3 )$$

We wish to minimize the number of transceivers, since it minimizes the overall cost of the setup. The optimzation assumes a number of side constraints: The design constraints are
[C1] The sidelobes levels are constrained to be at-least 15 dB below the mainlobe. This is to ensure that most of the power is directed towards the desired sector, as well as to limit the interference to the neighboring cells/sectors. The 3-dB beamwidth is required to be less than 4° and 15° for macro and small cell setup.
[C2] Limit the power variations in the beamforming coefficients σ(θ_{d}) 0 to 1 dB. This is required to ensure that the power amplifiers (PAs) will be efficient and operate in linear mode [14].
[C3] Limit the number of stages of the AFN factorization. This is done to ensure low complexity networks and minimize propagation of losses in the network.

The objectives are to (I) design the AFN and DBF weights to constrain the beampattern satisfying the spectral mask Δ_{d} as well as to restrict the dynamic range of PA output and (2) instantiate the AFN using passive microwave components while accounting for different beamtilts and insertion losses. We narrow the solution space formulating and solving the problems in the following order:
[P1-a] We initially relax the losses in microwave circuits and PA efficiency. Given a specific architecture and performance requirements, what are the bounds on the number of transceivers?
[P1-b] Subsequently for a given AFN and DBF order, is it possible to design the optimal weights satisfying the sidelobe levels and the dynamic range of the PA?
[P2] How do we factorize the AFN interconnects leading to a robust design? Can we represent the AFN using banks of microwave components and optimize their connections, weights and phase-shifts to minimize insertion losses for the set of beamtilts?

The above two problems form the core of the paper and their solutions are covered in the next three sections. The problem [P2] is subdivided depending on the objectives of the cellular architectures, and a detailed synthesis and analysis of such architectures and instantiations is provided in Sec. IV and V.

### III. Algorithms for Joint Optimization of AFN and DBF Weights

In this section, we consider the problems [P1a & b] and estimate the AFN and DBF weights for the desired outcome.

### A. Bounds on the Number of Transceivers

The introduction of AFN reduces the order of the adaptive beamformer to Nₚₐ. Unlike the modular AAA u(θ_{d}), which can be adaptively designed for all θ_{d} ∈ (−π/2:π/2]¹, the AFN arrangement can only satisfy a specific range of beamtilts R_{N}_{_{S}}={θ₁, . . . , θ_{N}_{_{S}}}. Before we proceed to derive AFN and DBF weights, it is important to derive the theoretical bounds on the number of transceivers Nₚₐ for a given R_{N}_{_{S}} achieving the desired SLL. ¹assuming ideal antenna elements

Let us start with the MSE cost function (3) and also assume that we can obtain the optimal beamformer weights u(θ_{d}) for the modular AAA. We will later explain the design procedure in Sec. III-C, also refer to [12], [13]. From (2), we get a LS approximation

Δ_{d} ≈A(θ)u(θ_{d}).

The AFN-DBF cost (3) can be rewritten utilizing the LS approximation of (2) as

$$\begin{matrix}\{ W , ν ( {θ}_{d} ) \} \approx arg {min}_{\{ W , ν ( {θ}_{d} ) \}} ∥ A ( θ ) u ( {θ}_{d} ) - A ( θ ) W ν ( {θ}_{d} ) ∥ ∀ {θ}_{d} ∈ \{ {R}_{θ} \} \\ \approx ∥ u ( {θ}_{d} ) - W ν ( {θ}_{d} ) ∥ ∀ {θ}_{d} ∈ \{ {R}_{θ} \}\end{matrix} \qquad ( 4 )$$

Stack u(θ_{d}) for the beamtilt range R_{N}_{_{S}} to obtain a Nₜ×N_{S} matrix:

U_{N}_{_{S}}=[u(θ₁), . . . , u(θ_{N}_{_{S}})].

The following Lemma characterizes the optimal AFN weights for beamtilt range R_{N}_{_{S}}.

Lemma 1: Consider a scenario [P1-a]: The AFN is made of ideal and lossless components and the PAs have infinite range. For a given Nₚₐ, the optimal weights of the feeder network must lie in the space Spanned by the dominant basis vectors of U_{N}_{_{S}}

W ∈ col span{U_{N}_{_{S}}}

Proof: Compute the singular value decomposition (SVD) U_{N}_{_{S}}:

$${u}_{{θ}_{d}} = U Σ {V}^{H} = [ {u}_{1} , ⋯ , {u}_{{N}_{pn}} , ⋯ ] [ \begin{matrix}{σ}_{1} & & \\ & {σ}_{2} & \\ & & ⋱\end{matrix} ] {V}^{H} ,$$

where U and V are the left and right singular vectors and Σ correspond to the singular values. For Nₜ≧N_{S}, any u(θ_{d}) can be obtained using a linear combination of U. If σₚₐ₊₁ ≈ 0, a linear combination of U(:,1:Nₚₐ)=u₁, . . . , u_{N}_{ₚₐ} using σ(θ_{d}) will result in u(θ_{d}), ∀θ_{d} ∈ R_{N}_{_{S}}. For σₚₐ₊₁>0, W=U(:,1:Nₚₐ) and given Nₚₐ, choosing W as the dominant basis vectors of U will provide the best Nₚₐ-rank representation.

A few remarks are in order:
This Lemma assumes that Nₜ≧N_{S}. The beamtilt range N_{S} can also be seen the resolution, and if Nₜ<N_{S}, then we can Nₜ mutually spaced θ_{d} from R_{N}_{_{S}} and proceed with Lemma 1.
This approach can also be seen as a more systematic and robust approach to conic up with the weights of the Blass matrix as in [15],
Note that this bound on optimal W does not consider feeder losses, dynamic range of the PAs as well the number of possible interconnects in the overall network. However, it does provide a starting point for updates that consider practical issues in the next sections.
The beamtilts for different sectors in a macro-AFN R_{N}_{_{S}} does not vary significantly from each other. However, the beamtilts for different sectors in a metro-AFN varies significantly, eventually limiting the losses in the feeder network.

Simulation results: Consider a macro-cell setup with Nₜ=11 antennas radiating at 2.6 GHz with each adjacent element uniformly spaced at a distance 0.8λ and designed to have a 3-dB beamwidth 65°. The simulations results shown in FIG. A2 provide a relation between the beamtilt range and minimum number of transceivers required to achieve SLL. X and Y axis respectively show the downtilt range and minimum number of transceivers, and Z axis plots the worst case SLL values for such configurations. In each case, the downtilt range corresponds to the maximum difference between any two elements in R_{N}_{_{S}}. We estimate the CFN weights using Lemma 1. These results show that we need atleast Nₚₐ=2 transceivers for a macro-cell scenario with downtilt range and achieve 18-20 db SLL. In practice, we need 3-4 transceivers to account for insertion loss, limited dynamic range of PA's and desired main-beam gain.

B. Algorithms to optimize AFN and DBF

Once we have established the minimum Nₚₐ required for the AFN, the next step is to design the AFN weights satisfying Δ_{d}. The focus of this sub-section is to include constraints in the original cost function (3) and to propose an interior point algorithm to estimate the weights. Our focus is to design the weights of optimal u(θ_{d}), progression from u(θ_{d} to designing the weights W follows Sec. III-A.

1) Introducing AFN constraints: A well known technique to estimate the beamformer weights for a specific beamtilt angle is the Capon or the minimum variance distortionless response (MVDR) approach [16]. The objective is to design the weights of u(θ_{d}) such that a main-lobe is focussed towards a specific sector, while minimizing the overall variance (i.e. power) transmitted in other directions. Mathematically, the above two conditions can be combined and written as

$$u ( {θ}_{d} ) = {min}_{u ( {θ}_{d} )} {u}^{H} ( {θ}_{d} ) u ( {θ}_{d} ) subject to ∥ {u}^{H} ( {θ}_{d} ) A ( θ ) ∥ = 1$$

In addition, we need u(θ_{d}) to satisfy a host of constraints. One such constraint defining the width of the mainbeam is the 3-dB beamwidth, and including it with the above constraint leads to

∥u^{H}(θ_{d})a(θ_{d})∥=1 and ∥u^{H}(θ_{d})a(θ_{3 dB})∥=1/\sqrt{2}

where θ_{3 dB} corresponds to angle providing half power beam width. Let θ_{SLL} correspond to list of angles which form the sidclobe of the desired beam pattern. To achieve a specific SLL (say ε_{dB}=20

TABLE 1
INTERIOR PROGRAM TO ITERATIVELY ESTIMATE u(θ_{d})

Given a strictly feasible u(θ_{d}) subject to u^{H} (θ_{d}) [symbol] _{εq} = e^{T},
tolerance t := t⁽⁰⁾, convergence parameter μ > 1 and tolerance τ > 0
compute an update of u(θ_{d}): u(θ_{d})*(t) = ∇² [ [symbol] (u)⁻¹] ∇ [ [symbol] (u)]
$\begin{matrix}where ( u ) = {u}^{H} ( {θ}_{d} ) u ( {θ}_{d} ) + \\ \frac{1}{t} log [ {u}^{H} ( {θ}_{d} ) [ a ( {θ}_{d} ) [ ε , … , ε ] - ( {θ}_{SLL} ) ] ] \\ and ▽ corresponds to the partial derivative with \\ respect to u ( {θ}_{d} ) .\end{matrix}$
update: u(θ_{d}) = u(θ_{d}) + u(θ_{d})*(t)
stopping criterion: quit if m/t < τ
step: t := μt

dB below the main lobe) the beamformer must also satisfy prescribed SLL constraint soecified by e, where e=10^{(t dB/20)}.

∥u^{H}(θ_{d})A(θ_{SLL})∥≦e

where A(θ_{SLL}) denotes the array response for the list of sidelobes. For notational simplicity, we do not distinguish betweel upper and lower SLLs. In practice, we keep unequal upper and lower sidelobe levels (for example have a strict LSL and relaxed USL constraint).

Combining all the above constraints, the central optimization problem can be formulated as follows:

$$\begin{matrix}{u}_{0} = arg {min}_{u ( {θ}_{d} )} {u}^{H} ( {θ}_{d} ) u ( {θ}_{d} ) \\ subject to & ( 5 ) \\ \vert {u}^{H} ( {θ}_{d} ) A ( θ ) \vert = 1 , \vert {u}^{H} ( {θ}_{d} ) a ( {θ}_{3 , dB} ) \vert = 1 \text{/} \sqrt{2} & ( 6 ) \\ \vert {u}^{H} ( {θ}_{d} ) A ( {θ}_{SLL} ) \vert \leq [ ε , ⋯ , ε ] & ( 7 )\end{matrix}$$

where (6) specifies the beamtilt constriants and (7) specifies the SLL constraints. The above cost function can be recast in the form of a convex optimization problem [11] usually described as

arg minₓ f₀(x)

subject to g(x)≦0 and h(x)=0

with equality and inequality constraints. The interest of expressing a problem in convex form is that although an analytical solution may not exist, it has been shown that such problems can be efficiently solved numerically and will always lead to optimal solution. One commonly used constrained optimization function is the interior point algorithm [11]. For details of the interior point algorithm to estimate beamformer weights, please refer to Table I and Appendix A. Note that the algorithm proposed here incorporates linear as well as quadratic constraints.

### C. Digital Beamformer Design

In the previous subsection we proposed an algorithm to estimate the weights of optimal AFN satisfying and SLLs. Note that the AFN is always used in combination with a digital beamformer to achieve the desired beam pattern. In other words, given the user signal s[k] and the array response a(θ_{d}) the AFN W is a function of σ(θ_{d}). Alternatively, the transmit-receive duality allows us to represent the DBF-AFN downlink setup as a AFN-DBF uplink setup with reversed signal flow [17]. Once the optimal AFN is designed as in III-B for a given range of downtilts, the DBF weights are a function of the AFN in the dual setup.

In this scenario, the objective is to design the DBF weights and minimize the cost

$${v ( {θ}_{d} )}_{0} = arg {min}_{ν} ∥ Δ ( {θ}_{d} ) - H ( {θ}_{d} ) ν ( {θ}_{d} ) ∥ where H ( {θ}_{d} ) = A ( θ ) W \qquad ( 8 )$$

where H(θ_{d}) is the beamspace array response for a given W and Δ(θ_{d}) is the desired spectral mask. A straightforward solution of the above cost is the LS estimate:

σ(θ_{d})=[H(θ_{d})]^{†}Δ(θ_{d})

DBF design with PA constraints: The DBF weights obtained from LS solution of the unconstrained problem (8) does not take into account the linear operating range of amplitude tapering. For this reason, we introduce an additional constraint that each DBF output is confined to a particular value or a particular range

$$\vert {ν}_{k} ( {θ}_{d} ) {\vert}^{2} = \frac{1}{{N}_{pn}} ∀ k ∈ \{ 1 , ⋯ , {N}_{pn} \} .$$

The cost (8) can be expressed including the per PA power constraint as

$${ν ( {θ}_{d} )}_{0} = {arg {min}_{ν}}_{\vert {ν}_{k} ( {θ}_{d} ) {\vert}^{2} = \frac{1}{{N}_{n}}} {ν ( {θ}_{d} )}^{H} ν ( {θ}_{d} ) \qquad ( 9 )$$

In addition, we can introduce the mainlobe, beamwidth and SLL similar to (5-7), and use the interior point approach as explained in Sec. III-B as well as [11], [13] to minimize (9). Please note that per antenna power constrained optimization is done over quadratic equality constraints (unlike the inequality and linear constraints as proposed in [13]). In some ways, this technique to design AFN and subsequently the DBF weights is similar to the joint design in [18].

### IV. Architectural Considerations of AFN

Please note that the Sections III-B and III-C provides some important conclusions on the design of AFN, however, they do not consider the limitations in architecture. Given that the hardware imposes significant limitations on the degrees of freedom, it is not possible to directly apply the results of Sec. III. This section proposes design changes for specific architectures.

### A. Two Stage Beamforming

The AFN-DBF arrangement can he seen as a two-stage transformation that steers the transmit beams towards a specific sector. The first stage i.e. DBF is an adaptive transformation for each beamtilt and has a straightforward implementation. However the second stage AFN is made of microwave components, and its implementation is not trivial, especially when the objectives are minimizing losses in the feeder network and providing distinct beampatterns for sectors.

Consider for example an AFN W, factorized into a bank of sub-matrices as shown in FIG. A4. Each sub-matrix comprises of a bank of power dividers (such as Wilkinson dividers or WDs), striplines/phase shifters and directional couplers [19, Ch. 7]. For example, we represent W using a filter-bank of power dividers D_{fb} and directional couplers R_{fb}

$$\begin{matrix}W = {D}_{fb} \times {P}_{1} \times {R}_{fb} \\ = ( {D}_{w 1} \times {D}_{w 1} \times {D}_{w 3} ) \times {P}_{1} \times ( {R}_{c 1} \times {R}_{c 2} ) .\end{matrix}$$

In the above expression, D_{wi} denotes a bank of power dividers for stage i and R_{ci} denotes a bank of hybrid coupler/combiner for stage i. The number of stages in the divider and coupler networks depends on the out-degrees between AFN and antennas. For a network made of 2 way dividers and couplers, the number of overall stages is always less than or equal to log₂[Nₜ].

In existing implementations of couplers/dividers, losses of 0.1-0.2 dB typically occur at each element. However, the most dominant losses in the feeder network are the insertion losses that typically result due to the amplitude and phase mismatch of the incoming signals at each combiner. If W does not have any non-zero element, the entire AFN can be represented using a bank of 3-port networks with:
1) (Nₜ−1) power dividers at connected to each PA or Nₚₐ(Nₜ−1) dividers in total.
2) (Nₚₐ−1) combiners connected to each antenna or Nₜ(Nₚₐ−1) combiners in total.
3) In addition, the elements of the AFN matrix are phase shifted to achieve the desired beam pattern (implemented using striplines or dielectrics).
   Such an implementation would lead to a complex network requiring many layers of interconnects. In addition, it is unlikely that the signals combined at the antenna to be matched in amplitude and phase, leading to significant amount of insertion losses. In other words, for efficient implementation, the number of combiners & power dividers must be kept to a minimum, and care must be taken to ensure that the amplitude and phase of each signal input to the combiner is always matched.

In a macro-cell modular AAA setup, the difference in beamtilt between adjacent sectors is less (<20°) and distance between the mobile user and base station is typically large as shown in FIG. A3(a). The emphasis for a macro-AFN is to design a narrow beam that preserves the same range as that of modular AAA, in other words minimize any losses that can occur in the feeder network. Alternatively, in a small cell modular AAA setup, the beamtilts between adjacent sectors is large (>20° refer to FIG. A3(b)) and the emphasis is to come up with a set of orthogonal beam patterns and tolerating some losses in the feeder network.

At this point the joint design problem {W, σ(θ_{d})} can be reclassified depending on the type of cellular architecture as
[D1] Redesign W and focus to minimize insertion lossses, subsequently design σ(θ_{d}) to optimize for beam pattern.
   This approach is typically suited for macro-cell cases.
[D2] Redesign W and focus to generate orthogonal beampatterns, sacricifinz on insertion loss.
   This approach is typically suited for a small-cell cases.
      Intutively, the designs [D1] and [D2] would lead to distinct factorizations of the AFN. We focus the rest of the section in the design of W and the design of σ(θ_{d}) follows Sec. III-C.

### B. [D1] Redesign W to Minimize Insertion Loss

Claim 1: Consider the scenario [P2], where the AFN has been factorized into a bank of hybrid directional couplers as shown in FIG. A4. Each bank is further divided into many stages of hybrid couplers. For an AFN design minimizing the insertion loss, the number of directional couplers in each stage R_{c, i} must not exceed Nₚₐ to minimize the insertion losses.

Proof: Insertion loss occurs due to the amplitude and phase mismatch at each coupler in the bank R_{c,i}. Note that the adaptive DBF σ(θ_{d}) has Nₚₐ dimensions or degrees of freedom and for each value of θ_{d}, these weights are adaptively modified to either minimize insertion loss or optimize beam pattern. From linear estimation theory, the Nₚₐ×1 vector σ(θ_{d}) can at-most account for insertion loss at N, combiners nodes in each. Thus, to minimize the insertion losses in the AFN it is essential to limit the number of combiners to Nₚₐ.

Considering that R_{c, i} typically has dimensions greater than Nₚₐ, this result specifies that R_{c,i} minimizing insertion loss has to be a sparse matrix.

Claim 2: Given a Nₜ×Nₚₐ setup, with Nₜ>>Nₚₐ, it is reasonable to assume that the number of antenna elements connected to a given PA is always greater than 1. For reasonable grating-lobe and SLL, the spacing between adjacent antenna elements that are connected to a given PA must not be much greater than λ/2.

Proof: Each column of the AFN can be seen as a fixed beamformer connected to each PA. The adaptive DBF combines different beams from the AFN using Nₚₐ degrees of freedom to enable the two-stage beamforming. Grating lobes and side-lobes usually occur in any antenna array beamforming setup, where the antenna spacing is greater than λ/2. if the adjacent antenna elements connected to each PA is spaced much greater than λ/2. the fixed stage beamformer will always produce side-lobes and grating lobes, and the reduced dimension (Nₚₐ) adaptive DBF will not be able to suppress all the side-lobes and grating lobes them for the entire range of downtilts. For this reason, it is necessary to limit the spacing between antenna elements connected to a given PA.

The λ/2 spacing is applicable for an omni-directional antenna element. This spacing is somewhat relaxed in practice for a directional array. For a broadside element commonly used in 3GPP with 3-dB beamwidth ≈65°, the array spacing must be limited to 0.8λ.

1) Orthogonal matching pursuit: The Claims 1 and 2 allow us to conclude that the antennas connecting a given PA are grouped together and in a given coupler stage R_{c.i}, any two PA's will be joined at only one antenna. Let us denote a spatial interconnection map as a Nₜ×Nₚₐ matrix S=[s₁, . . . , s_{N}_{ₚₐ}] and satisfying the Claims 1 and 2. For example, in a 11×3 case s₁=[1₅, 0₆]^{T} and s₁=[0₄, 1₃, 0₄,]^{T}. The AFN satisfying the interconnects S is re-designed using a modified version of the orthogonal matching pursuit [20], [18] as follows:

Note that [u₁, . . . u_{N}_{ₚₐ}, . . . ]=Basis{U_{θ}_{_{d}}}.

for k ∈ {1, . . . , Nₚₐ}
Recompute SVD(U_{θ}_{_{d}})=[u₁, U_{N}].
Extract the AFN weights satisfying the spatial interconnects: wₖ=sₖ \textcircled{·}u₁.
Normalize each column of wₖ.
W=[w₁, . . . wₖ].
Compute the orthogonal projection: U_{θ}_{_{d}}=(I−WW^{H})U_{θ}_{_{d}}.

end k

Final AFN: W=[w₁, . . . w_{N}_{ₚₐ}].

The Orthogonal matching pursuit is chosen, since it provides with a low-complexity implementation (when compared to brute search techniques) and shown in [20] to converge to optimal performance for large Nₚₐ.

2) Decomposition of power divider bank D_{fb}: Note that W ∈ C^{N}^{ₜ}^{×N}^{ₚₐ}. The magnitude of the non-zero elements in wᵢ correspond to power divider implementations from i^{th} PA and the phase of the elements of wᵢ correspond to appropriate phase shifts or line length implementations. From the interconnect map S, the PA outputs might be divided N_{i,dir}=[Nₜ/Nₚₐ+1] times before phase-shifted and combined. Representing these elements using a one-shot N_{i, div}×1 vector might lead to impractical realizations. For this reason, each PA output is successively factorized into 3-port WDs. In this regard, the successive factorization of WDs is similar to radix-2 FFT representation of a higher order DFT.

For design implementations, the first two stages of WDs-D_{w, 1} and D_{w, 2} consists of balanced dividers and the unbalanced dividers [19] are usually reserved for the last stage. Subsequently, each output of the final stage D_{w, 3} is connected to a bank of phase shifters P as shown in FIG. A4. In our implementation. P is a diagonal matrix whose elements correspond to arbitrary phases along the unit circle. Note that the phase shifts in P is already modified by the corresponding power ratios.

3) Decomposition of hybrid coupler bank R_{fb}: The output of P is transformed using R_{fb} and fed on to Nₜ antennas. For efficient operation of R_{fb}, it is essential that the input signals into each directional coupler be matched in terms of amplitude and phase and any mismatch in terms of amplitude/phase will result in insertion losses. In cases, when the input signals are not matched at a given stage (say R_{c, i}), the insertion losses must be propagated to the next stage R_{c, i+1} for suppression.

For this reason, we use hybrid elements, such as rat-race couplers or branch hybrids as combiners. In a rat-race coupler, ports 2 and 3 the input ports and the sum and the difference of the inputs are coupled to ports 1 and 4 respectively [19, Pg. 480]. Please note that port 4 (also referred to as the isolation port) extracts the out of phase insertion loss. The prime reason in using a hybrid element is that a given stage R_{c, i} any phase or amplitude mismatch can be captured using the isolation port of hybrid coupler. Exploiting the linear phase property of the antenna array as well as the AFN setup, the port 4 output can subsequently be recirculated as input to the next stage R_{c, i+1} accounting for the insertion loss. These hybrid elements can either be branch hybrids (commonly used in Butler matrix implementations [8]) or rat-race hybrids. In our setup, we use rat-race hybrid elements, the motivation being
Four port rat-race couplers can also be seen as radix-2 DFT or FFT implementation. Higher order DFTs can then be obtained using different arrangements of such couplers.
The two-stage beamformer used with the antenna array setup has a linear phase property, symmetric to the central antenna element(s). This intuitively suggests that the signals at the isolation port of one rat-race coupler contains the same phase as the signal at the output port of the another rat-race coupler.

4) Insertion loss minimization using linear phase couplers: The techniques proposed in Sec. III and IV leads us to u(θ_{d}) (and subsequently W and σ(θ_{d})) having linear phase i.e.

|uᵢ(θ_{d})|=|u_{N}_{ₜ}₋ᵢ(θ_{d})| and ∠uᵢ(θ_{d})−∠u_{N}_{_{d}}_{/2}(θ_{d})=±(∠u_{N}_{ₜ₋ᵢ}(θ_{d})−∠u_{N}_{ₜ}_{/2}(θ_{d}).

This linear phase observation can be also be seen in {W, σ(θ_{d})}. Consider a 11×5 AFN as shown in FIG. A6, where there is a mismatch in phase the incoming signals at the couplers RR_{L} and RR_{U} of R_{c, 1}. This mismatch is reflected in the port 4 of RR_{L} and RR_{U}. Exploiting the symmetry in the architecture and the linear phase of the signals at each stage of AFN, map the isolation ports (port 4) of R_{c, 1} to the input port (port 3) of R_{c, 2}. This modification, in combination with the corresponding re-design of σ(θ_{d}) equalizes the phase mismatch at the combiners.

### C. [D2]: Redesign W to Optimize Orthogonal Beams

In a metro/small cell scenario, the objective is to design beamtilts spaced 30° apart. In such cases, the focus of AFN design is more towards providing orthogonal beam patterns and is a fundamentally different from designing a [D1] narrow main-lobe and minimizing insertion loss. We start with the AFN and DBF weights as in Sec. III.

1) Existing architectures: Given a requirement to generate say orthogonal and provide beamtilts {−30, 0, +30} when used with a spacing antenna array, one well known technique is to use a Butler matrix [8]. This matrix has Nₜ inputs and Nₜ outputs, connecting Nₜ PAs and Nₜ antennas and implemented using, branch or rat-race hybrids with low losses. To generate a given beam pattern, only one PA is turned on. Example of such an approach is shown in FIG. A7 to generate three beams at {−30, 0, +30}. The main disadvantages with this technique are that it usually requires Nₜ inputs, and the radiated power is low since only one PA (or two as shown FIG. A7) is operational at a given time.

On the other hand, if we directly implement the AFN matrix as designed in Sec. III, the result will be a generalized approach to design a Blass matrix and Nolen matrix [15]. Typically, the Blass matrix performs a QR decomposition or Gram-Schmidt orthogonalization of the AFN. The authors [15] implement a lossless version of the Blass matrix but have only one PA operating at a given time.

2) Generalized Butler matrix: We refer to our small-cell AFN as generalized Butler matrix. Such decompositions of Butler-like beamformers using hybrid elements provides:
1) representaion of generalized Butler matrix using FFT, leading to low complexity factorizations of AFN using hybrid couplers (as explained in [21], [10]).
2) Similar to [D1], extract and recirculate insertion loss (Sec. IV-B.3).

One crucial difference with [D1] is that in this case, the Claim 1 cannot be satisfied, if our focus is on designing Orthogonal beam patterns. For this reason, the OMP design technique proposed in Sec. IV-A is not valid for [D2]. Please note that claim 2 is the necessary condition to avoid grating lobes and for this reason, all possible AFN designs must satisfy claim 2.

The alternative configurations of FIGS. A7(a) and (b) are specific instances of Butler matrices. In general, our objective is to come up with generic factorizations of AFN. As explained before, the focus is to make the metro-AFN matrix more sparse, with reduced number of combiners. Such a factorization would simplify the matching the combiner inputs and subsequently minimize the insertion losses while achieving the desired beam pattern.

Given a Nₜ×Nₚₐ AFN, the number of combiners connected to a given antenna is specified by the row weight and the number of splits is specified by the column weight. The phase shifts are specified by matrix multiplication of non-zero terms. Reducing the number of combiners would require us to organize the AFN matrix such that matrix multiplication i.e. phase shifts are the dominant operation. One well known approach to achieve this transformation is through Cholesky factorization [22, Chap. 3]. For example, consider a 4×3 AFN decomposed as the following lower and upper triangular matrices:

$$W LDU \\ [ \begin{matrix}{W}_{11} & {w}_{12} \\ {W}_{21} & {w}_{22}\end{matrix} ] \begin{matrix}= \\ =\end{matrix} [ \begin{matrix}{L}_{11} & 0 \\ {L}_{21} & {l}_{22}\end{matrix} ] [ \begin{matrix}{I}_{2} & 0 \\ 0 & {s}_{22}\end{matrix} ] [ \begin{matrix}{U}_{11} & {u}_{12} \\ 0 & {u}_{22}\end{matrix} ]$$

where s₂₂ is known as the Schur complement: s₂₂-w₂₂-L₂₁U₁₂. This factorization does not alter the the overall response of the AFN. In other words, there is no change in σ(θ_{d} as well as the corresponding beam pattern. The upper and lower triangular structures suggests that the number combiners in each factor is significantly reduced, and provides an easy way to quantify insertion losses in each stage.

This factorization can be repeated on L₂₁ to further decompose L. Though the Cholesky factorization is preferred for square matrices, such approaches can be modified for any rectangular matrices (such as 6×3 and 8×3 arrangements). Please note that the complexity of matrix factorizations is not an issue, since the AFN design is one-shot and kept subsequently fixed.

### V. Simulation Results

To assess the performance of the AFN-DBF architectures, we have applied to macro and small cell multi-antenna base stations. We present simulation results for AFN algorithms and architectures proposed in Sec. III and Sec. IV. These results include computing the beampatterns for different configurations, sectors and the corresponding insertion loss values. The performance indicators are usually

1 The radiated energy along the sector centered at θ_{d} and satisfying the required USL and LSL values.

2 Effect/propagation of the insertion loss in different stages of the CFN design and beamtilt values.

### A. [D1]: Beam Pattern Optimization and Insertion Loss Computation

The base station with the AFN antenna array beamforms and transmits the desired signal towards specific sectors spaced θ_{d} ∈ {0°, . . . , 20°}. In a macro-setup, the number of antennas is usually Nₜ=10-12, θ_{3. dB}≦5⁰ and SLLs are restricted to the order of 16-18 dB. The amplitude tapering of the DBF weights connecting each PA is restricted to be in the range 0-1 dB, to facilitate the PAs in a linear mode of operation. The antenna elements antennas are spaced 0.8λ apart. Note that the critical spacing is 0.5λ and this increased spacing i.e. or spatial sub-sampling is required to account for transition towards wide-band setup. Thus, we have an additional challenge of suppressing the grating lobes. The focus of the AFN design for the [D1] case is to minimize insertion loss.)

1) Vertical sectorization for different Nₚₐ and θ_{d}: FIG. A8(a) shows the beampatterns for Nₚₐ=4, Nₜ=11 providing 3 sectors spaced θ_{d}=0°, 5°, and 10°. Curve 2 shows the performance of the modular AAA setup, and curves 1, 3 and 4 show the performance of AFN arrangement. Comparing curves 2 and 3, the results show that the results of the fully adaptive modular AAA with Nₚₐ=12 DBF weights are inseparable with the results of the partially adaptive AFN arrangement. Both these approaches provide 24 dB SLL, θ_{3. dB}=5° for a radiated power of 10 dB along beamtilt 5°. As we move towards sector θ_{d}=0° and θ_{d}=10°, the SLL performance of the AFN arrangement slightly degrades from 24 dB to 18.5 dB. However, radiated power of the AFN along θ_{d} is still preserved.

FIG. A8(b) shows the beampatterns for different AFN arrangements with Nₚₐ={2-5} and Nₜ=11. The AFN is initially designed for the sectors θ_{d} ∈{0°, . . . , 10°}. Subsequently, the curves 1-4 show a snapshot of the performance, when we introduce a new sector at θ_{d}=12°. Note that all these designs optimize for insertion loss. Curves 1 (Nₚₐ=4) and 2 (Nₚₐ=5) respectively show 16 and 18 dB SLL, while achieving θ_{3. dB}=5°. As expected, the performance significantly degrades when an AFN arrangement with Nₚₐ=2 and shown by curve 2. To account for design flexibility and address different θ_{d}, it is necessary to keep Nₚₐ≧3.

2) Insertion loss for different AFN architectures: FIG. A9(a) shows the average phase mismatch at the combiners for the 11×5 setup for different beamtilts θ_{d} ∈ 0°, . . . , 30°. Note that the insertion loss is proportional to the phase mismatch at the combiners (The rat-race couplers subsequently used are balanced couplers). Curve 1 shows the AFN result of Sec. III, and this result can also be seen as an instance of the lossy Blass matrix [15]. In Curves 2 and 3 respectively show the performance of the proposed AFN arrangement Sec. IV-B.2 and IV-B.3. Comparing curves 1 and 2, the results show that decomposing AFN using orthogonal matching pursuit as explained in Sec. IV-B.3 significantly minimizes the insertion loss. As the beamtilt range increases, it becomes important to use hybrid couplers and compensate for the insertion loss as explained in Sec.IV-B.3. Note though, that the ILMR approach performs poorly for θ_{d} ∈ {13° . . . 17°}, this is due to some amplitude mismatch in the combiners. For this reason we choose either the approach mentioned in Sec. IV-B.2 or the approach mentioned in IV-B.3 as per the beamtilt range.

### B. [D2]: Orthogonal Beam Patterns for Small Cells

The base station with AFN antenna array beamforms and transmits the desired signal towards specific sector spaced θ_{d} ∈ {−30°, . . . , +30°}. In these cases, the PAs typically radiate 0.5W power. The base-station antennas are spaced 0.5λ apart, and chosen antenna element has a 3-dB beamwidth of 110°. In a small-cell setup, the number of antennas Nₜ=4-6, the 3-dB beamwidth restriction is lifted and SLLs are restricted to the order of 10-15 dB. The amplitude tapering of the DBF weights connecting each PA is relaxed to be in the range 0-3 dB. The focus in this case is to account for orthogonal beam patterns, while sacrificing on the insertion loss performance.

Effect of number of transceivers Nₚₐ and downtilt range θ_{d}: FIGS. A10(a) shows the beampatterns for Nₚₐ=2, Nₜ=4 providing 3 sectors spaced θ_{d} ∈ {−30°, 0°, +30°}. Note that the array response a(θ_{d}) for each θ_{d} is orthogonal to the other. Thus for Nₚₐ=2, we will never satisfy the Lemma 1, and such a setup will always lead to sub-optimal performance as confirmed by curves 1 and 3. In FIG. A10(b), increasing the number of transceivers and number of antennas Nₚₐ=3 and Nₜ=6, it is possible to achieve 10 dB SLL suppression where all the PAs operating, at a constant power as shown in FIG. A10(b). In practice, we will use a Nₜ=6 configuration for improved SLL as explained in Sec. VI.

### VI. Network Instantiations

### A. Metro AFN Instantiation

In the following, one possible instantiation of the 3-to-6 AFN of a small cell base station capable of steering its main beam from −30° to +30° off the broadside direction is presented. The block diagram of a specific instantiation is depicted in FIG. A11.

It is composed of 5 discrete stages of power dividing/combining and phase-shifting networks. The inputs of this AFN are the three signals x=(x1, x2, x3) that are generated by three different transceivers. The 1st stage of the AFN is composed of three 1-to-3 power dividers that split the signal of each transceiver into three components. These dividers are generally unbalanced and, therefore, even though the output signals of each divider are phase-matched they are not equal in magnitude. The 2nd stage of this AFN is composed of nine 1-to-2 power dividers. Each of these dividers generates two instances of each of the 9 output signals of the 1st stage of dividers. Similar with the first stage, all the 1-to-2 power dividers of this 2nd stage are unbalanced. The 3rd stage of this AFN is composed of eighteen static phase-shifting elements that properly set the phase of any of the outputs of the 2nd stage of the AFN. The individual amounts of the phase introduced by each of the phase-shifters of the 3rd stage and also the power-split ratios of the power dividers of the first two stages are determined by the optimization algorithm presented the previous sections of this paper. As a result, in the general case, the output signals of the 3rd stage of this AFN both amplitude-unbalanced and phase-unmatched. The 4th stage of the 3-to-6 AFN is different for the signals that originate from the first transceiver (instances of x1) and different for the signals that originate from the remaining two transceivers (instances of x2 and x3). For the latter, this stage is composed of six 2-to-1 power combiners that add up any two consecutive output signals of the 3rd stage, as shown in Fig. Given that the output signals from the 3rd stage are not matched in amplitude and phase, it should be expected that the power combiners of this stage would be inherently lossy. Minimizing these for a given set of input signals should be one of the constraints that have to be satisfied as part of the optimization algorithm. For the former signals, the 4th stage is composed of phase-shifting components that should minimize the phase mismatch between the output signals of the power combiners of this stage and the signals which do not go through such combiners. Finally, the last (5th) stage of this AFN consists of 2-to-1 power combiners that the signals from the phase-shifters of the 4th stage with the signals of the power combiners of the 4th stage. For the same reasons that the power combiners of the 4th stage have been shown to be lossy, the power combiners of the 5th stage are inherently lossy, as well, and their properties (power-combining ratio) should be optimized both in terms of the required functionality and the minimization of the overall losses. The AFN of Fig. has been implemented using standard microstrip technology. For the considered instantiation, the ratios of all the employed power combining/splitting components have been varying from 10 dB to 12 dB. These components have been implemented either as unbalanced Wilkinson dividers [19] (for power ratios up to 5 dBs) or as directional couplers [19] (for the power ratios from 5 dB to 12 dB). As far as the phase-shifting components are concerned, they have been implemented using standard microstrip-based transmission lines. The exact length of each of these lines has been dictated by the required phase-shift to be inserted. FIG. A12 compares the beampattern and SLL performance of the circuit instantiation with that of the simulations results proposed in Sec. V-B.

### APPENDIX

### A. Interior Point Algorithm

Our goal is to formulate the inequality constraint in (7) as a set of equality constraints. These equality constraints can be subsequently used in combination with the Newton method [11] to iteratively solve for u(θ_{d}). Given that |u^{H}(θ_{d})A(θ)|=1,

$$\frac{{u}^{H} ( {θ}_{d} ) A ( {θ}_{SLL} )}{{u}^{H} ( {θ}_{d} ) a ( {θ}_{d} )} \leq [ ε , ⋯ , ε ] leading to$$

$${u}^{H} ( {θ}_{d} ) [ a ( {θ}_{d} ) [ ε , ⋯ , ε ] - A ( {θ}_{SLL} ) ] \geq 0 or {u}^{H} ( {θ}_{d} ) ℐ ( {θ}_{d} ) \geq 0$$

Similarly, we can rewrite the equality constraints as follows:

u^{H}(θ_{d})[A(θ), a(θ_{3 dB})]=[1, 1/\sqrt{2}] [symbol] u^{H}(θ_{d})A_{eq}=e^{T}

The basic idea of the interior point approach is to introduce an indicator function I(θ_{d}) is to make the inequality constraints implicit in the cost function (5). This is achieved by using I(θ_{d}) in the original cost (5) and rewritten as

$${u ( {θ}_{d} )}_{0} = arg min {u}^{H} ( {θ}_{d} ) u ( {θ}_{d} ) - \frac{1}{t} log [ ( {θ}_{d} ) ] \\ subject to {u}^{H} ( {θ}_{d} ) {A}_{eq} = {e}^{T} \qquad ( 10 )$$

where t corresponds to step size. Given an initial estimate, these interior point type approaches iteratively update u(θ_{d}) and eventually resulting in the optimal solution. The rate of convergence of iterations usually depend t, convergence parameter μ and tolerance τ as briefly mentioned in Table I. For details refer to [11]. The initial estimate of u(θ_{d}) is obtained from the MVDR solution, and the iterative updates are obtained as explained in Table I where P(u) corresponds to the RI-IS of (10).

### REFERENCES

[1] D. Gesbert. M. Shafi, D. Shiu, P. J. Smith, and A. Naguib, “From theory to practice: an overview of MIMO space-time coded wireless systems.” IEEE Journal on Selected areas in Communications. vol. 21. no. 3. pp. 281-302, March 2003.
[2] 3GPP TR 36.814. Evolved Universal Terrestrial Radio Access E-UTRA: Further advancements for E-UTRA physical layer aspects. March 2010.
[3] A. Hajimiri, H. Hashemi, A. Natarajan, X. Guang, and A. Babakhani, “Integrated phased arrays systems in silicon.” Proceedings of the IEEE. vol. 93. no. 9. pp. 1637-1655. September 2005.
[4] P. E. Haskell. “Phased array antenna system with adjustable electrical tilt,” Patent, November 2008.
[5] X. Zong, Y. Wu, and P. Zhou. “Studies on the new-typed feed network with a single variable phase shifter for wireless base antennas,” in Antennas Propagation and EM Theory (ISAPE). 2010 9th International Symposium on. 29 2010-Dec. 2 2010. pp. 240 -243.
[6] X. Zhang, A. F. Molisch, and S. Y. Kung. “Variable phase shift based RF baseband codesign for MIMO antenna selection.” IEEE Transactions Signal Processing. vol. 53, no. 11, pp. 4091-4103. November 2005.
[7] B. D. van Veen and R. Roberts, “Partially adaptive beamformer design via output power minimization.” IEEE Transactions Signal Processing, vol. 11, pp. 1524-1532, November 1987.
[8] J. Butler and R. Lowe, “Beam-forming matrix simplifies design of electrically scanned antennas,” Electron Design. vol. 9, pp. 170-173. April 1961.
[9] D. Parker and D. Zimmermann, “Phased arrays-part ii: implementations, applications, and future trends.” Microwave Theory and Techniques. IEEE Transactions on. vol. 50, no. 3, pp. 688-698. march 2002.
[10] J. Shelton. “Fast fourier transforms and butler matrices,” Proceedings of the IEEE. vol. 56. no. 3. p. 350. March 1968.
[11] S. Boyd and L. Vandenberghe, Convex Optimization. Cambridge University Press, 2006.
[12] D. Palomar, J. Cioffi, and M. Lagunas, “Joint tx-rx beamforming design for multicarrier mimo channels: a unified framework for convex optimization,” Signal Processing. IEEE Transactions on. vol. 51, no. 9. pp. 2381-2401, september 2003.
[13] W. Yu and T. Lan, “Transmitter optimization for the multi-antenna downlink with per-antenna power constraints.” Signal Processing. IEEE Transactions on, vol. 55. no. 6, pp. 2646-2660, june 2007.
[14] B. Razavi, RF Microelectronics. Prentice Hall. 1998.
[15] S. Mosca, F. Bilotti, A. Toscano, and L. Vegni, “A novel design method for blass matrix beam-forming networks.” Antennas and Propagation, IEEE Transactions on. vol. 50. no. 2, pp. 225-232, february 2002.
[16] M. H. Hayes. Statistical Digital Signal Processing and Modeling. John Wiley and Sons, 2002.
[17] P. Viswanath and D. Tse, “Sum capacity of the vector gaussian broadcast channel and uplink-downlink duality,” Information Theory, IEEE Transactions on, vol. 49. no. 8. pp. 1912-1921. august 2003.
[18] V. Venkateswaran and A. J. van der Veen. “Analog beamforming in MIMO communications with phase shift networks and online channel estimation.” IEEE Transactions on Signal Processing, vol. 58, no. 8, pp. 1431-1443. August 2010.
[19] D. M. Pozar, Microwave Engineering, 2nd ed. John Wiley & Sons. Inc, 2004.
[20] S. Mallat and Z. Zhang, “Matching pursuits with time-frequency dictionaries,” IEEE Transactions Signal Processing. vol. 41. no. 12. pp. 3397-3415. December 1993.
[21] M. Ueno. “A systematic design formulation for butler matrix applied fft algorithm,” Antennas and Propagation. IEEE Transactions on. vol. 29, no. 3, pp. 496-501. may 1981.
[22] G. H. Golub and C. F. van Loan. Matrix Computations. Johns Hopkins University Press. 1993.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

The functions of the various elements shown in the Figures, including any functional blocks labelled as “processors” or “logic”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” or “logic” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the Figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

1. An antenna feed for generating signals for an antenna array for transmitting a transmission beam having one of a plurality of different tilt angles, said antenna feed comprising:
a digital signal processor operable to receive an input broadband signal and to generate, in response to a requested tilt angle, a plurality N of output broadband signals, each having an associated phase and amplitude;
a plurality N of transmission signal generators, each operable to receive one of said plurality N of output broadband signals and to generate a corresponding plurality N of first RF signals;
a feed network operable to receive said plurality N of first RF signals and to generate a plurality P of second RF signals, each of said plurality P of second RF signals having an associated amplitude and phase, said plurality P of second RF signals being used to generate a plurality M of third RF signals, where P is no less than M, each third RF signal having an associated phase and amplitude for supplying to a corresponding antenna of a plurality M of antennas of said antenna array to transmit said transmission beam with said requested tilt angle.

2. The antenna feed of claim 1, wherein said feed network comprises a power split network operable to receive said plurality N of first RF signals and to generate a plurality P of power split RF signals, wherein P is greater than N.

3. The antenna feed of claim 2, wherein said power split network comprises a plurality of stages, each comprising power splitters, each stage dividing received RF signals over at least two separate paths and providing those to a subsequent stage to generate said plurality P of power split RF signals.

4. The antenna feed of claim 1, wherein said feed network comprises a phase shift network operable to receive said plurality P of power split RF signals and to apply a phase shift on each of said plurality P of power split RF signals.

5. The antenna feed of claim 4, wherein said phase shift network is operable to receive said plurality P of power split RF signals and to generate a plurality P of phase shifted RF signals as said plurality P of second RF signals.

6. The antenna feed of claim 4, wherein said phase shift network comprises interconnects operable to reorder said plurality P of phase shifted RF signals.

7. The antenna feed of claim 4, wherein said feed network comprises a coupling network operable to receive said plurality P of phase shifted RF signals and to combine some of said plurality P of phase shifted RF signals to generate said plurality M of third RF signals, where M is less than P.

8. The antenna feed of claim 7, wherein said coupling network comprises combiners operable to combine received signals to generate a combined signal and a loss signal, said loss signal being combined with other received signals to reduce losses at different tilt angles.

9. The antenna feed of claim 7, wherein said coupling network comprises a plurality of stages, each comprising combiners, loss signals from a previous stage being provided to a combiner of a subsequent stage to generate said plurality M of second RF signals.

10. The antenna feed of claim 9, wherein each stage comprises fewer than the plurality P of combiners.

11. A method of configuring an antenna feed for generating signals for an antenna array for transmitting a transmission beam having one of a plurality of different tilt angles, said method comprising:
estimating an arrangement of a feed network which optimises performance for said plurality of different tilt angles, said feed network being arranged to receive a plurality N of first RF signals and to generate a plurality P of second RF signals, each of said plurality P of second RF signals having an associated amplitude and phase, said plurality P of second RF signals being used to generate a plurality M of third RF signals, where P is no less than M, each third RF signal having an associated phase and amplitude for supplying to a corresponding antenna of a plurality M of antennas of said antenna array to transmit said transmission beam with said requested tilt angle;
reconfiguring said arrangement of said feed network to minimise insertion losses; and
determining a function applied by a digital signal processor to generate, from an input broadband signal, in response to a requested tilt angle, a plurality N of output broadband signals, each having an associated phase and amplitude to be provided to a plurality N of transmission signal generators, each being operable to receive one of said plurality N of output broadband signals and to generate a corresponding one of said plurality N of first RF signals.

12. The method of claim 11, wherein said estimating comprises using an interior point algorithm to estimate all possible arrangements of said feed network for said antenna array and plurality of different tilt angles.

13. The method of claim 11, wherein said estimating comprises using singular value decomposition to estimate, from said all possible arrangements, said arrangement of said feed network which optimises performance for said plurality of different tilt angles.

14. The method of claim 11, wherein said reconfiguring comprises utilising an orthogonal matching pursuit algorithm and factorisation rules in conjunction with said arrangement of said feed network to reconfigure said arrangement of said feed network to minimise insertion losses.

15. The method of claim 11, wherein said determining comprises estimating said function by minimising a mean squared cost function utilising performance constraints, an antenna response model and a feed network model.
